(19) United States
(12) Patent Application Publication
(10) Pub. No.: US 2019/0174319 A1
(43) Pub. Date: Jun. 6, 2019

(54) DETECTION AND IDENTIFICATION OF POTENTIALLY HARMFUL APPLICATIONS BASED ON DETECTION AND ANALYSIS OF MALWARE/SPYWARE INDICATORS

(71) Applicant: Seven Networks, LLC, Marshall, TX (US)

(72) Inventors: Ari Backholm, Los Altos, CA (US); Ross Bott, Half Moon Bay, CA (US); Dustin Morgan, Marshall, TX (US); Colby Adams, Marshall, TX (US)

(21) Appl. No.: 16/206,020

(22) Filed: Nov. 30, 2018

Related U.S. Application Data
(60) Provisional application No. 62/593,865, filed on Dec. 1, 2017.

(51) Int. Cl. H04W 12/12; H04L 29/06; H04W 12/00

(52) U.S. Cl. CPC H04W 12/1208; H04L 63/1425; H04W 12/002; H04L 63/0281; H04L 63/145

(57) ABSTRACT

Systems and methods for detecting and identifying malware/potentially harmful applications based on behavior characteristics of a mobile application are disclosed. One embodiment of a method of detecting a potentially harmful application includes detecting behavior characteristics of a mobile device and, based on those detected behavior characteristics, identifying one or more indicators that the mobile application is a potentially harmful application. Those indicators are then analyzed to determine whether the application is a potentially harmful application.

### PRIORITY

This application claims priority to U.S. Provisional Patent Application No. 62/593,865 filed on Dec. 1, 2017 entitled “DETECTION AND IDENTIFICATION OF POTENTIALLY HARMFUL APPLICATIONS BASED ON DETECTION AND ANALYSIS OF MALWARE/SPYWARE INDICATORS,” the entire contents of which are incorporated by reference herein.

### TECHNICAL FIELD

The disclosure relates to systems, apparatus, and methods to monitor and maintain mobile device health, including malware detection, identification, and prevention. These systems, methods, and apparatus focus on a device activity and data traffic signature-based approach to detecting and protecting against undesirable execution of applications on mobile communication devices.

### BACKGROUND

Mobile malware incidence has recently surged significantly in view of the prevalence of mobile application sharing, downloading, and installation from communal application market places. Mobile malware contains code that can compromise personal data and consume a user's data plans and/or voice-based minutes. Mobile malware can also enable bypassing of firewalls and have further impact by hijacking USB synchronization and affect any synced computer or laptop, or make way into enterprise servers.

With mobile users now downloading and installing mobile applications from these marketplaces (e.g., Google Play Store, Apple App Store, or Apple iTunes Store) where software applications are made by any developer around the world, malware can easily be repackaged into applications and utilities by any party and uploaded to these online application market places. Mobile device security has thus become a critical and urgent task in the increased reliance on mobile devices for everyday business, personal, and entertainment use.

Applications executing on a mobile device provide a continuous source of information that can be used to monitor and characterize overall “device health,” which in turn can impact the device's ability to execute applications with maximum efficiency and user quality of experience (QoE). Information that can characterize device health includes most aspects of the wireless traffic to and from the device, as well as state and quality of the device's wireless radios, status codes and error messages from the operating systems and specific applications, CPU state, battery usage, and user-driven activity such as turning the screen on, typing, etc. Once a model is developed for what expected device activity is, deviations from this model can be used to alert the user about possible threats (e.g., malware), or to initiate automatic corrective actions when appropriate.

One way of detecting malware is to develop code signatures for specific malware and use this code signature to match against code that has been or is about to be downloaded onto a device. These so-called code signature-based malware detectors, however, depend on receiving regular code signature updates to protect against new malware. Code signature-based protection is only as effective as its database of stored signatures.

Another way of detecting malware is to use an anomaly-based detection system for detecting computer intrusions and misuse by monitoring system activity and classifying it as either normal or anomalous. The classification is based on heuristics or rules, rather than patterns or signatures, and attempts to detect any type of misuse that falls outside of normal system operation. This contrasts with code signature-based system which can only detect attacks for which a code signature has previously been created. This so-called anomaly-based intrusion detection also has some short-comings, namely a high false-positive rate and the ability to be fooled by a correctly delivered attack.

Accordingly, a need exists for malware protection that is both dynamic and accurate. Specifically, there is a need for a method, device, and/or system for identifying mobile applications that are potentially harmful applications (i.e., applications that are or contain malware or spyware, or otherwise inappropriately track user data and/or behavior) that does not rely on determining, updating, or matching code signatures and that avoids a high false-positive rate.

### SUMMARY

A malware detector is disclosed. The malware detector includes a data traffic monitor that detects data traffic of a mobile application on a mobile device. The malware detector includes an activity monitor that detects characteristics of behavior of the mobile application. The malware detector includes an analysis engine that identifies, based on the data traffic of the mobile application and the characteristics of behavior of the mobile application, one or more indicators that the mobile application is a potentially harmful application and determines, based on an analysis of the one or more indicators, whether the mobile application is a potentially harmful application.

In one embodiment of the malware detector, the analysis engine identifies one or more indicators that the mobile application is a potentially harmful application based on upload activity of the mobile application.

In one embodiment of the malware detector, the upload activity used to identify one or more indicators includes data traffic containing personal information about a user of the mobile application or the mobile device.

In one embodiment of the malware detector, the analysis engine identifies one or more indicators that the mobile application is a potentially harmful application based on behavior of the mobile application while the mobile application is operating in the background.

In one embodiment of the malware detector, the behavior of the mobile application while the mobile application is operating in the background includes tracking the user's behavior on the mobile device.

In one embodiment of the malware detector, the analysis engine uses machine learning to identify one or more indicators that the mobile application is a potentially harmful application and to determine whether the mobile application is a potentially harmful application.

In one embodiment of the malware detector, the malware detector is communicatively coupled to a remote server that provides information to the malware detector that the analysis engine uses for identifying that the mobile application is a potentially harmful application.

A mobile device is disclosed. The mobile device includes a memory. The mobile device includes a processor. The processor of the mobile device is configured to monitor data traffic associated with a mobile application of the mobile device. The processor of the mobile device is configured to monitor device behavior of the mobile device. The processor of the mobile device is configured to detect malware based on the data traffic and the device behavior. The processor of the mobile device detects malware by identifying one or more indicators and analyzing the one or more indicators.

In one embodiment of the mobile device, the one or more indicators used to detect malware are identified based on upload activity of the mobile application.

In one embodiment of the mobile device the upload activity that is used to identify one or more indicators includes data traffic containing personal information about a user of the mobile application or the mobile device.

In one embodiment of the mobile device, monitoring the device behavior includes monitoring activities of the mobile application while the mobile application is operating in the background.

In one embodiment of the mobile device, the processor identifies one or more indicators when the mobile application is operating in the background based on the mobile application tracking the user's behavior on the mobile device while the mobile application is operating in the background.

In one embodiment of the mobile device, analyzing the one or more indicators includes comparing the one or more indicators with information determined using machine learning.

In one embodiment of the mobile device, the processor is further configured to flag detected malware.

A method of detecting a potentially harmful application is disclosed. The method includes monitoring data traffic of a mobile application on a mobile device. The method includes detecting characteristics of behavior of the mobile application. The method includes identifying one or more indicators that the mobile application is a potentially harmful application, wherein the one or more indicators are based on the data traffic of the mobile application and the characteristics of behavior of the mobile application. The method includes analyzing the one or more indicators to determine whether the mobile application is a potentially harmful application. The method includes classifying the mobile application as a potentially harmful application based on the analysis of the one or more indicators.

In one embodiment of the method of detecting a potentially harmful application, the one or more indicators are based on upload activity of the mobile application.

In one embodiment of the method of detecting a potentially harmful application, the one or more indicators are based on behavior of the mobile application while the mobile application is operating in the background.

In one embodiment of the method of detecting a potentially harmful application, a threshold associated with a first indicator is determined using machine learning.

In one embodiment of the method of detecting a potentially harmful application, a threshold associated with a first indicator is determined based on information provided by a third party.

In one embodiment of the method of detecting a potentially harmful application, classifying the mobile application as a potentially harmful application is based on the presence of a plurality of indicators.

### BRIEF DESCRIPTION OF THE DRAWINGS

FIG. 1A depicts an example diagram showing observations of traffic and traffic patterns made from applications on a mobile device.

FIG. 1B illustrates an example diagram of a system where a host server 100 performs some or all of malware detection, identification, and prevention based on traffic observations.

FIG. 1C illustrates an example diagram of a proxy and cache system distributed between the host server and device which facilitates network traffic management between a device, an application server or content provider, or other servers such as an ad server, promotional content server, or an e-coupon server for resource conservation and content caching. The proxy system distributed among the host server and the device can further detect and/or filter malware or other malicious traffic based on traffic observations.

FIG. 2A depicts a block diagram illustrating an example of client-side components in a distributed proxy and cache system residing on a mobile device (e.g., wireless device) that manages traffic in a wireless network (or broadband network) for resource conservation, content caching, traffic management, and malware detection, identification, and/or prevention.

FIG. 2B depicts a block diagram illustrating a further example of components in the cache system shown in the example of FIG. 2A which is capable of caching and adapting caching strategies for mobile application behavior and/or network conditions. Components capable of detecting long poll requests and managing caching of long polls are also illustrated.

FIG. 2C depicts a block diagram illustrating examples of additional components in the local cache shown in the example of FIG. 2A which is further capable of performing mobile traffic categorization and policy implementation based on application behavior and/or user activity.

FIG. 2D depicts a block diagram illustrating additional components in the malware manager and filter engine shown in the example of FIG. 2A.

FIG. 3A depicts a block diagram illustrating an example of server-side components in a distributed proxy and cache system that manages traffic in a wireless network (or broadband network) for resource conservation, content caching, traffic management, and/or malware detection, identification, and/or prevention.

FIG. 3B depicts a block diagram illustrating examples of additional components in proxy server shown in the example of FIG. 3A which is further capable of performing mobile traffic categorization and policy implementation based on application behavior and/or traffic priority.

FIG. 3C depicts a block diagram illustrating additional components in the malware manager and filter engine shown in the example of FIG. 3A.

FIG. 4 depicts a flow chart illustrating an example process for using request characteristics information of requests initiated from a mobile device for malware detection and assessment of cache appropriateness of the associated responses.

FIG. 5 depicts a flow chart illustrating example processes for analyzing request characteristics to determine or identify the presence of malware or other suspicious activity/traffic.

FIG. 6 depicts a flow chart illustrating example processes for malware handling when malware or other suspicious activity is detected.

FIG. 7 depicts a flow chart illustrating an example process for detection or filtering of malicious traffic on a mobile device based on associated locations of a request.

FIG. 8 depicts a flow diagram illustrating an example of a process for performing data traffic signature-based malware protection according to an embodiment of the subject matter described herein.

FIG. 9 depicts a block diagram illustrating an example of a computing device suitable for performing data traffic signature-based malware protection according to an embodiment of the subject matter described herein.

FIG. 10 depicts a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure include detection and/or filtering of malware based on traffic observations made in a distributed mobile traffic management system.

One embodiment of the disclosed technology includes a system that detects potentially harmful applications (e.g., malware) on a mobile device through a comprehensive view of device and application activity including: application behavior, user behavior, current application needs on a device, application permissions, patterns of use, and/or device activity. Because the disclosed system is not tied to any specific network provider it has visibility into application behavior and activity across all service providers. This enables malware to be detected across a large sample group of users, in some embodiments using machine-learning and artificial intelligence to identify potentially harmful applications.

In some embodiments, this can be implemented using a local proxy on the mobile device (e.g., any wireless device) that monitors application behavior and data traffic. The local proxy can analyze the application's behavior and data traffic to detect and/or identify potentially harmful applications using indicators or other flags. A remote server may further analyze the application behavior and data traffic in light of numerous other instances of that application running on other mobile devices to further detect and/or identify potentially harmful application using indicators or other flags.

### Detecting/Identifying a Potentially Harmful Application

Malware is malicious software that is designed to damage or disrupt a computing system, such as mobile phone. Malware can include a virus, a worm, a Trojan horse, spyware, or a misbehaving application. A mobile application that is malware or spyware, or contains malware or spyware (either intentionally or unintentionally), or otherwise inappropriately tracks and/or uploads user data and/or user behavior is potentially a harmful application. One way to identify a harmful application candidate is to analyze its data traffic patterns and/or other behavior characteristics to determine whether the application is potentially spying on a user or otherwise inappropriately tracking user data/behavior.

The subject matter described herein includes data traffic signature-based malware protection. In contrast to conventional configurations, which use code signatures for identifying and protecting against malware, the present disclosure includes device activity signature-based detection and protection against malware.

For example, all code, whether it is malware, well-intentioned code that is acting badly unbeknownst to the user, or code that is acting normally, can be represented by an abstraction of the data traffic that the code creates over time when it executes. This abstraction can be translated into a device activity signature associated with a particular computing device, such as a mobile phone. This device activity signature can then be compared with other similar devices or with future device activity signatures from the same device.

The nature and degree of difference between one device activity signature and a reference device activity signature can then be used to apply a policy decision for the device. Applying a policy decision can include defining an event trigger and a paired action. The event trigger can include, for example, an anomalous rise in data traffic associated with a potentially harmful application or that application opening an unexpected communications port. The paired action for each event trigger can be different depending on the seriousness of the triggered event. For example, the paired action can range from noting the event in a log file to the immediate blocking of all activity associated with an application.

The device activity signature can be updated as new applications or usage patterns are associated with the device. Dynamically updating the device activity signature allows for a more refined classification of device activity as either normal or anomalous, which can help to eliminate false-positives. Changes in traffic patterns that potentially cause event triggers may be “expected changes,” and therefore not indicative of anomalous activity/malware. For example, a download of a new known application may generate an additional traffic pattern that is incorporated into the device activity signature. By considering application downloads initiated by the user, traffic pattern changes caused by these applications may not trigger an associated policy action.

Another example of an expected change in traffic pattern that may be accounted for by the traffic signature includes an increase in traffic associated with a specific application that is correlated with increased user screen time for that application. When a user is using a new application and the screen is on, activity generated by that application may be much less likely to be indicative of malware. Yet another example of an expected change in traffic pattern, which may be accounted for by the traffic signature, includes a gradual increase in traffic over time from an application. Gradual increases in traffic may be much less likely to be associated with malware than a sudden and significant increase in traffic. Yet another example of an expected change in traffic pattern, which may be accounted for by the traffic signature, includes new types of activity, such as the use of a new port by an application. Many non-malware applications utilize certain ports and, therefore, even a sudden use of a previously unused port may not be indicative of malware.

The malware detection described herein can be used in conjunction with, and complementary to, code signature-based methods for device protection. While code signature-based methods aim to catch and block malware before it is executed, the present subject matter can detect and prevent abnormal code behavior using detected traffic patterns after the code has executed.

There are numerous criteria that can be taken into account when attempting to determine whether an application is a potentially harmful application. A malware detector can analyze data traffic activity and/or device activity/behavior when looking at these numerous criteria to determine whether an application is a potentially harmful application. These criteria can be referred to as indicators or flags. For example, when a mobile application uploads data, it may be uploading that data as part of tracking a user's behavior and/or data, or performing some other malicious action. Thus, an upload event can be an indicator.

In one embodiment, a malware detector, as part of analyzing data traffic and/or device activity/behavior, can use an upload event as an indicator to detect a potentially harmful application. The malware detector can monitor an application's upload events to identify whether the application is a potentially harmful application. For example, one indicator of an upload event that can be used to determine whether the application may be a potentially harmful application can be when the application's upload event includes a larger data set during uplink transmissions (i.e., from the mobile device to a server) than during downlink transmissions (i.e., from a server to the mobile device). Another indicator of an upload event that can be used to determine whether the application can be a potentially harmful application is whether or not the upload event uses APIs that are intended for reporting data. One example of an API that is intended for reporting data is Google Analytics for Firebase.

In one embodiment, a malware detector, as part of analyzing data traffic and/or device activity/behavior, can monitor the frequency of an application's uploads to use as an indicator to detect a potentially harmful application. The malware detector can detect patterns in the application's upload frequency, such as detecting patterns based on the time-of-day of one or more uploads or the day-of-the-week of one or more uploads. The malware detector can also detect patterns based on more complex time series of one or more uploads.

In one embodiment, a malware detector, as part of analyzing data traffic and/or device activity/behavior, can monitor the size of an application's uploads to use as an indicator to detect a potentially harmful application. The malware detector can detect a potentially harmful application based on the size of the application's uploads. For example, larger upload sizes can be an indicator of a higher probability that the application is maliciously reporting a user's data as part of the uploads.

In one embodiment, a malware detector, as part of analyzing data traffic and/or device activity/behavior, can monitor the destinations of an application's uploads to use as an indicator to detect a potentially harmful application. For example, the destination or destinations of an application's uploads can be compared to a list of known suspicious destinations to determine whether an application may be a potentially harmful application. The known destinations can be identified, for example, through machine learning or through offline analysis. The machine learning or offline analysis to identify known destinations can be performed by one or more remote cloud servers that communicate with the mobile device.

In one embodiment, a malware detector, as part of analyzing data traffic and/or device activity/behavior, can monitor an application's data transfer that occurs while the application is in various states to use as an indicator to detect a potentially harmful application. The various application states that can be detected by the malware detector include, for example, when the application is in the background or when the application is in the foreground but is not in interactive use by a user. A data transfer from an application, such as an upload of data, while the application is in the background or is not in interactive use, may indicate that the application is a potentially harmful application.

In one embodiment, a malware detector, as part of analyzing data traffic and/or device activity/behavior, can monitor an application's upload activity to detect uploads that take place either immediately after or within a period of time after the application has been installed or initialized to use as an indicator to detect a potentially harmful application. The period of time within which the malware detector can detect uploads after installation/initialization can be a specific amount of time, or it can be an amount of time that varies based on the behavior of the application and/or the user. By identifying immediate or nearly immediate data uploads, the malware detector can identify applications that attempt to collect a small amount of data from a user upon installation of the application before the user has a chance to uninstall and/or deactivate the application.

In one embodiment, a malware detector, as part of analyzing data traffic and/or device activity/behavior, can monitor an application's upload activity to detect uploads that include more than one destination to use as an indicator to detect a potentially harmful application. For example, when an application uploads data to more than one destination, that can be an indicator that the application may be a potentially harmful application. The multiple destinations can include, for example, Internet destinations that are known or suspected to be associated with malware, cloud servers that are known or suspected to be associated with malware, or any other destination(s) that would not otherwise be expected to be an upload destination given the context of the application and its upload behavior. The uploads that can be monitored for multiple destinations can include, for example, data uploads as well as the application's API usage.

In one embodiment, a malware detector, as part of analyzing data traffic and/or device activity/behavior, can monitor an application's upload activity to detect data patterns in the uploads to use as an indicator to detect a potentially harmful application. For example, an application's uploads may include a data field that contains a constant data value across multiple uploads for a particular user, but contains a different value across multiple uploads for a different user. Such a pattern in upload data can be an indicator that an application has assigned a user identifier to a user for potentially tracking user behavior.

In one embodiment, a malware detector, as part of analyzing data traffic and/or device activity/behavior, can detect when an application is operating in the background to use as an indicator that an application may be a potentially harmful application. For example, regardless of whether an application is actively uploading data, an application that is operating in the background can be an indicator that the application may be tracking user behavior and/or storing data for later upload. Certain application behavior can be a further indicator that an application may be a potentially harmful application. For example, when an application performs one or more actions to avoid being killed by the operating system when the operating system attempts to free up memory or clean up unused applications, such action may be an indicator that the application is tracking user behavior. Similarly, when an application restarts itself after being killed by the operating system, that may be an indicator that the application is tracking user behavior. When an application performs one or more actions or other activities that could prevent the application from being considered inactive by the operating system (e.g., so that the application appears active) could be an indicator that the application is tracking user behavior. The malware detector can monitor the frequency and/or other patterns of activity that occurs in the background, which can be used as an indicator that the application may be a potentially harmful application. For example, an application's use of APIs and/or other routines that allow for application wake-up in the background without performing an activity that would otherwise be expected can be used as an indicator that an application is tracking user behavior. One such example of an application performing a wake-up or other similar action for a background fetch, without accessing the network, can be considered an activity that lacks the expected activity (i.e., network access).

In one embodiment, a malware detector, as part of analyzing data traffic and/or device activity/behavior, can detect when an application seeks and/or acquires certain permissions, which can be used as an indicator that an application may be a potentially harmful application. For example, some types of permissions that can be tracked as indicators can include the application's ability to determine which application is in the foreground, the application's ability to retrieve user information, the application's ability to access contacts and/or calendar, and/or the application's ability to determine a user's location, either at a coarse level or a fine level.

In one embodiment, a malware detector, as part of analyzing data traffic and/or device activity/behavior, can detect when an application performs actions that require a user's permission and/or require a disclosure to the user but that do not actually receive the user's permission or do not make the required disclosure to the user, which can be used as an indicator that an application may be a potentially harmful application.

In one embodiment, a malware detector, as part of analyzing data traffic and/or device activity/behavior, can analyze a privacy policy associated with an application to use as an indicator that the application may be a potentially harmful application. For example, the malware detector can identify topics within a privacy policy that may indicate that an application is tracking user behavior. This information can be used as an indicator that an application developer assumes that users do not read the privacy policy and, therefore, unintentionally give legal permission to track the user's behavior. In addition, the malware detector can further compare topics from the privacy policy associated with the application to the actual operation and/or activity of the application (e.g., permissions requested and/or granted, application activity, data uploads by the application) to identify discrepancies between the privacy policy and the corresponding application behavior.

In one embodiment, a malware detector, as part of analyzing data traffic and/or device activity/behavior, can detect when a first application accesses the activities of other applications to use as an indicator that the first application may be a potentially harmful application. For example, a malware detector can detect when an application has the ability to and/or does access another application's activities, or when an application has the ability to and/or does observe what another application draws and/or shows on the screen of a mobile device (e.g., take screenshots), or when an application has the ability to and/or does observe another application's network traffic (e.g., metadata of network traffic, data of network traffic).

The malware detector of the present disclosure can be configured such that the presence of one indicator does not trigger a warning that an application may be a potentially harmful application but the presence of multiple indicators, together, does trigger such a warning. Conversely, the malware detector can be configured such that the presence of a single indicator triggers a warning that an application may be a potentially harmful application. The number of indicators needed to trigger a warning can be customized, for example, by a user, by an application developer, or by a third party running a communal marketplace (e.g., Google Play Store, Apple App Store, or Apple iTunes Store). Further, the malware detector can be configured such that multiple indicators being present at the same time (e.g., frequency of uploads while the application is in the background, and the application's background activity within 24 hours of being installed) triggers a warning, or it can be configured such that multiple indicators being present independently (e.g., background uploads and large uploads in foreground) triggers a warning. Further, the malware detector can be configured such that the indicators are arranged/grouped in a hierarchy or other type of priority classification, so that the presence of indicators within one or more hierarchy level can lower the threshold for triggering a warning resulting from the presence of indicators within one or more other hierarchy levels. For example, the presence of uploads while an application is in the background may lower the triggering threshold when the malware detector detects the presence of uploads of varying frequency, size, destination, etc.

In one embodiment, third-party services can be used to provide one or more of the indicators that identify an application as a potentially harmful application.

In one embodiment, the flags and/or thresholds used by the malware detector to trigger an indicator are configurable. They can be configured by a user, by an application developer, or by a third party running a communal application marketplace (e.g., Google Play Store, Apple App Store, or Apple iTunes Store). Alternatively, they can be configured using machine learning. For example, the flags and/or thresholds can be machine-learned using supervised learning against known malware or malware flags by one or more other malware tracking mechanisms or defined by offline analysis. Some examples of the methods and/or models that can be used to machine-learn the flags and/or thresholds include, for example, support vector machines, linear regression, logistic regression, naïve Bayes classifiers, linear discriminant analysis, decision trees, k-nearest neighbor algorithms, and/or neural networks. Additionally, the flags and/or thresholds can be machine-learned using unsupervised learning to identify important features and/or flags that characterize different malware types, which can be used to define important features and/or hierarchies using principal component analysis, clustering, and/or neural networks. The machine learning to identify flags and/or thresholds can be performed by one or more remote cloud servers that communicate with the mobile device.

In one embodiment, the malware detector, as part of analyzing data traffic and/or device activity/behavior, can perform flagging of indicators on a number of different bases. For example, flagging of indicators can be performed on a user-by-user basis or on an application-by-application basis. Flagging of an application as malware can be based on the application getting flagged because a user count or user density (e.g., within a population that can be global, certain geography, certain device model, operating system, or other feature that can be used to segment the population) crosses a threshold. The threshold can be either manually defined or machine-learned, and it can be specified to balance the competing interests of sensitivity and avoidance of false alarms. User-by-user analysis can be performed at the device, or it can be performed by a server, or partly by both.

In one embodiment, flagging can be performed across a user population, for example, by using a user identifier, either by partially processing data on each device and evaluating patterns across devices on a server/network side, or the device providing raw data entries to the server and server processing them to find patterns.

In one embodiment, flagging of identifiers can be considered version-specific (e.g., affecting a specific version of an application only) or can apply to all versions, or a subset of versions, of an application. Having one or more versions of an application flagged can be used as an identifier for other versions of the application, including past versions.

In one embodiment, the checking for flags and/or evaluation of indicators for an application to determine if the application is or contains malware can be performed upon installation of the application, shortly after installation of the application, or periodically while the application is installed. It can be triggered by a change in one or more of the indicators, or at any other time. The evaluation can be performed on user devices in production, on user devices in a dedicated test group, on user devices in a lab, or on simulated user devices.

In one embodiment, the processing required for analyzing data traffic and/or device activity/behavior can be performed locally on a mobile device, remotely by one or more cloud servers, or in any combination by dividing the processing between a mobile device and the remote server(s). For example, raw information associated with the data traffic and/or device activity/behavior can be uploaded by a mobile device to the remote cloud server(s) that can then perform data-intensive processing using mathematical analysis, statistical analysis, or machine learning or other types of artificial intelligence to analyze the data and identify indicators and determine whether and application is a potentially harmful application. The cloud server(s) can then communicate with the mobile device to provide the mobile device with the results of the analysis and instruct the mobile device how to handle the potentially harmful application. In the situation where the processing is shared between the mobile device and the cloud server(s), the mobile device and the cloud server(s) can use different processing techniques and/or algorithms to analyze the data, given their different available processing resources and power constraints. The mobile device can perform different types and/or levels of analysis based on whether and how much additional processing support is available from the cloud server(s). For example, when the cloud server(s) are unavailable (e.g., because the mobile device is offline, because the network is congested, or because a potentially harmful application is already interfering with or blocking the mobile device's network activity), the mobile device can perform the processing locally.

In one embodiment, when some or all of the processing required for analyzing data traffic and/or device activity/behavior to identify indicators and determine whether and application is a potentially harmful application is performed by one or more remote cloud servers, the cloud server(s) can use in their processing data that has been aggregated from uploads from multiple devices. For example, raw information uploaded from a population of mobile devices can be more useful in detecting a potentially harmful application than just the information uploaded from a single mobile device analyzed in isolation. When using information aggregated from many mobile devices, the cloud server(s) can identify global patterns of device activity/behavior that would not otherwise be apparent. The aggregated data can be used as inputs into the mathematical analysis, statistical analysis, or machine learning or other types of artificial intelligence to analyze the data and identify indicators and determine whether and application is a potentially harmful application.

In one embodiment, when the logic for the malware detector is stored and/or operated on the device, the logic may be updated remotely. For example, as the algorithms and analysis used to detect a potentially harmful application become more complex and more intelligent, updates can be pushed to a mobile device to update the mobile device's local processing logic. Similarly, when the remote cloud server(s) collect more raw data that is used for the analysis, patterns, trends, or other indicators from the data can be pushed to a mobile device to update the mobile device's local processing logic.

In one embodiment, past data of or relating to indicators may be stored to allow reprocessing when the logic and/or algorithms of the malware detector are updated. The past data may be stored either on a user device or at a server. The past data may be stored either locally on a mobile device or remotely at one or more cloud servers, or both.

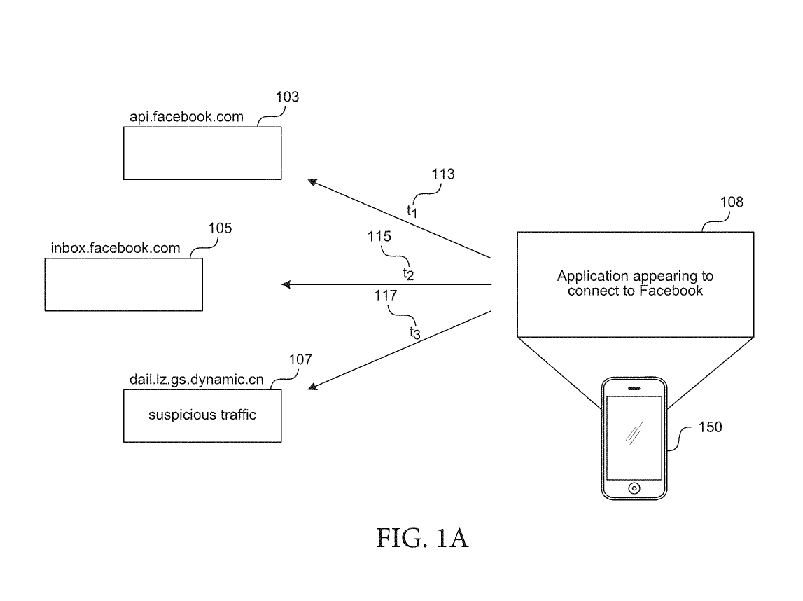

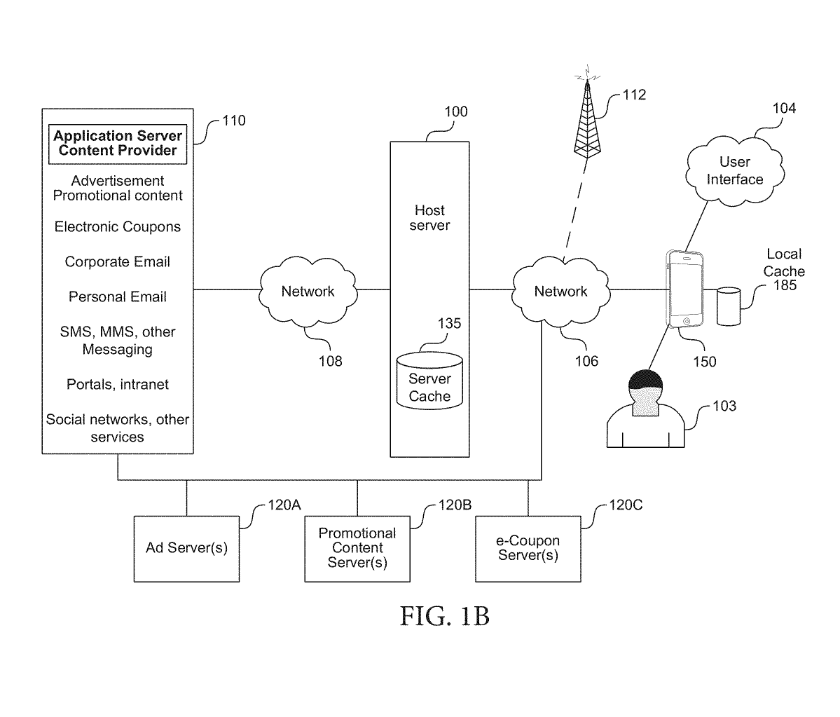

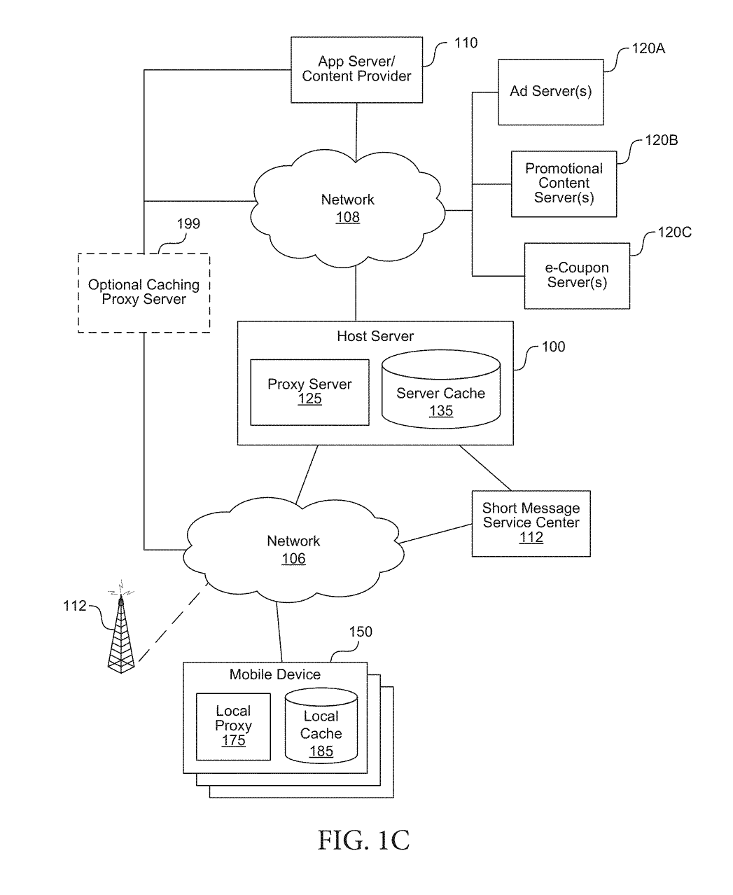

FIG. 1A depicts an example diagram showing observations of traffic and traffic patterns made from applications 108 on a mobile device 150 used by a distributed traffic management system (illustrated in FIG. 1B-FIG. 1C) in detecting or filtering of malware.

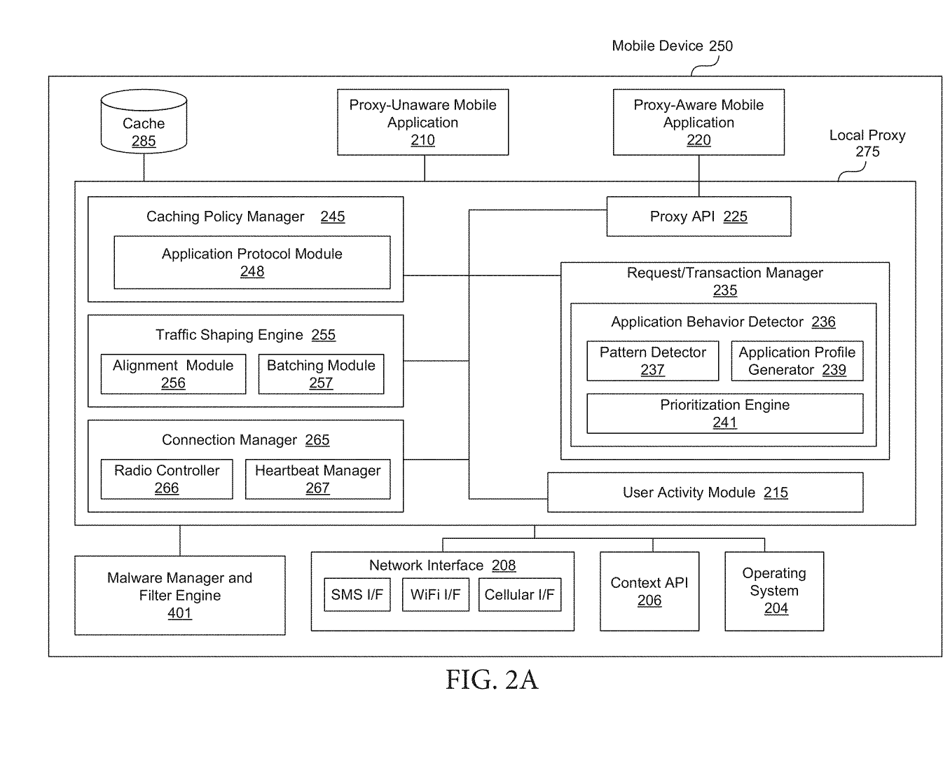

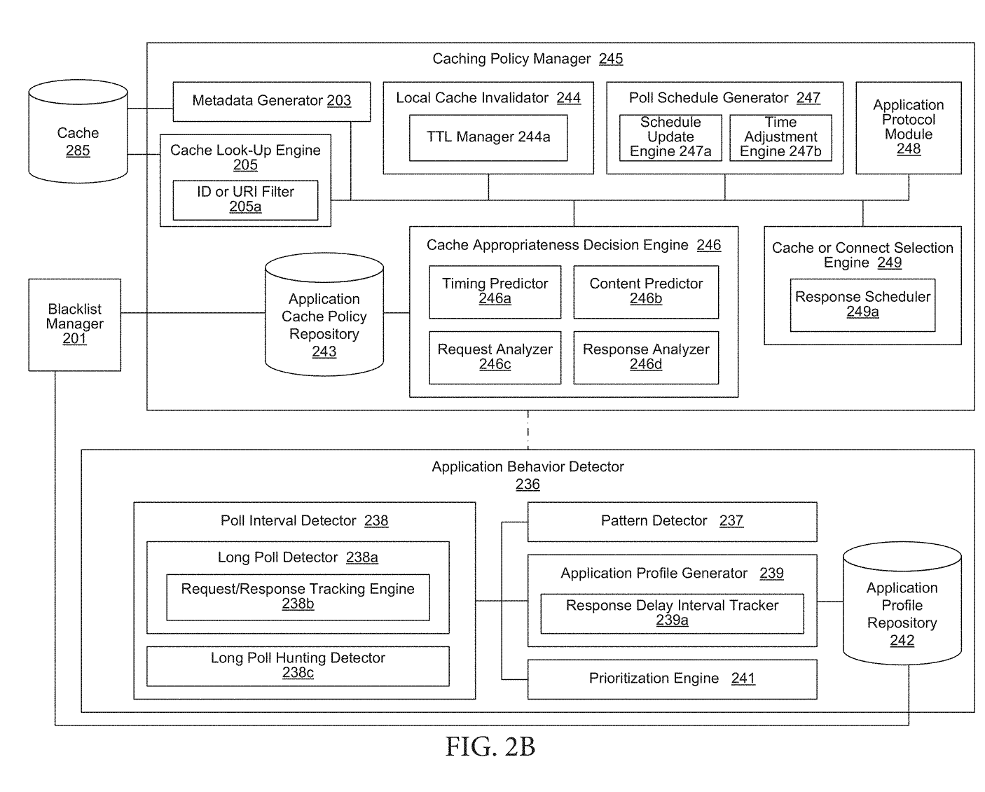

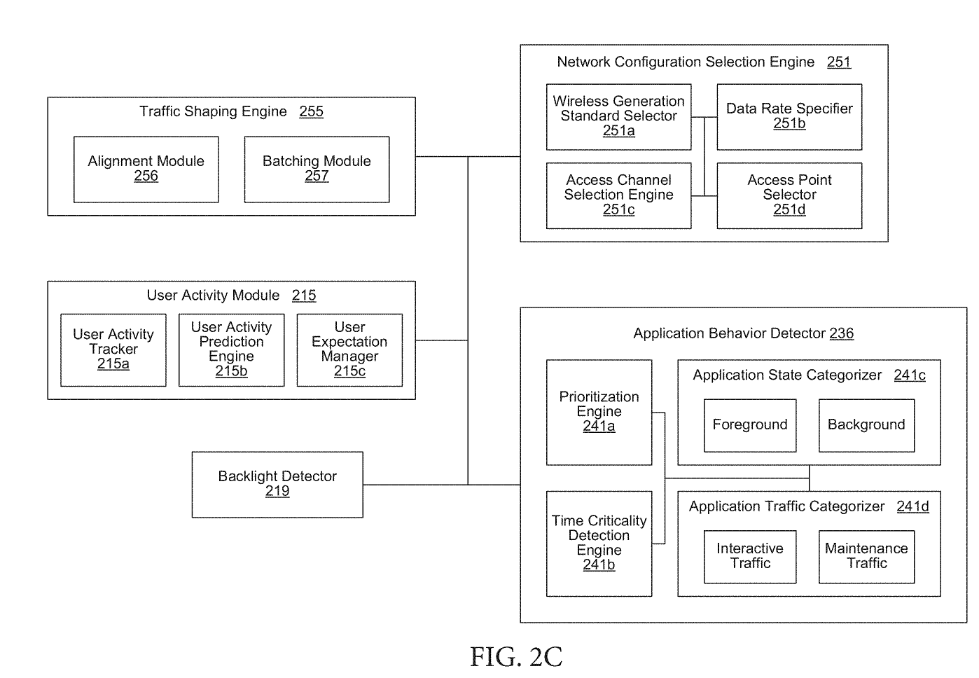

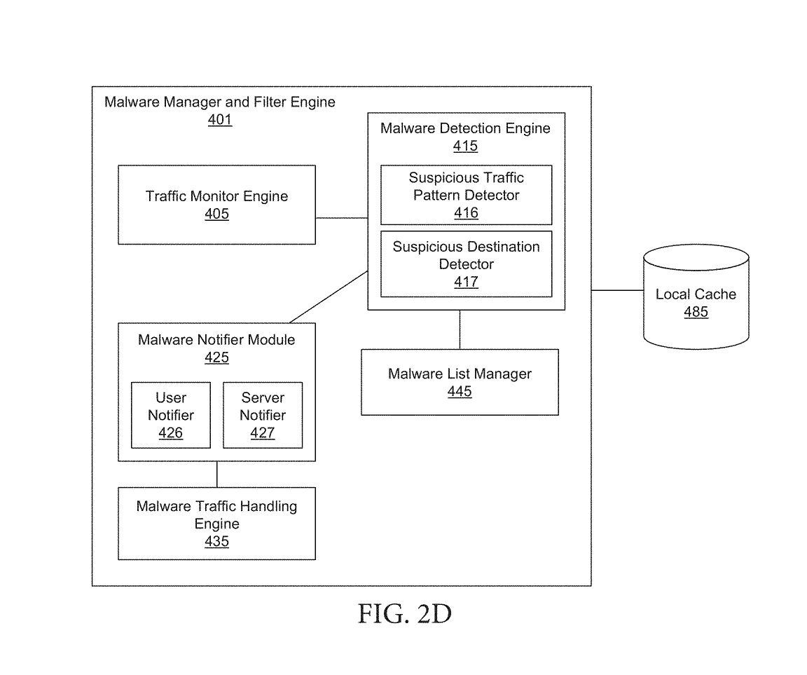

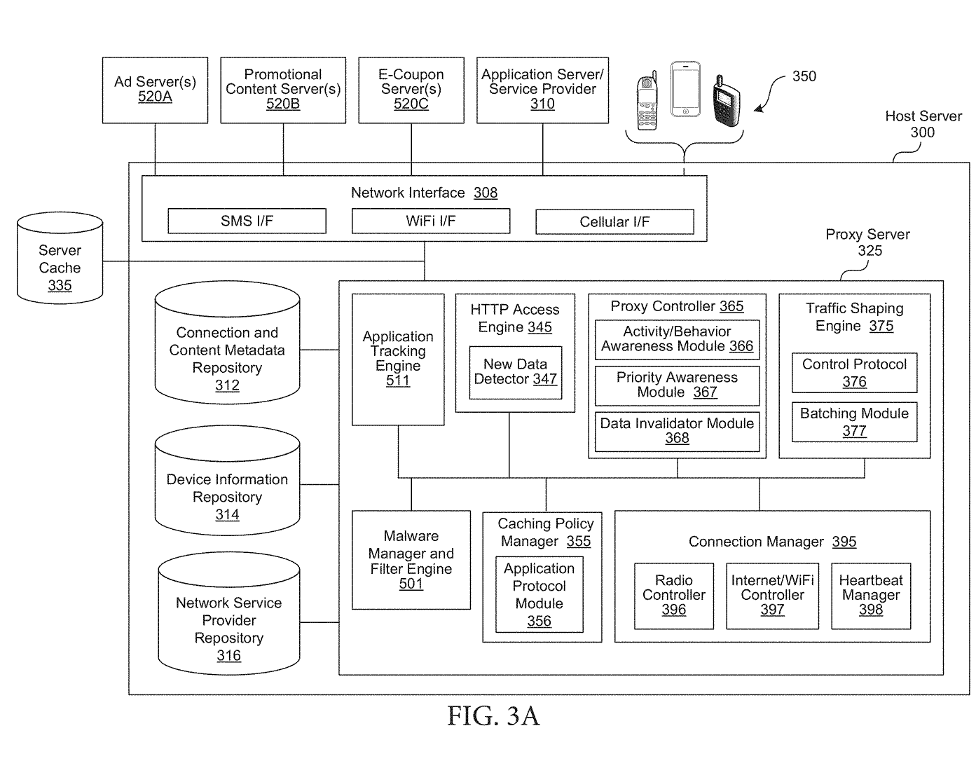

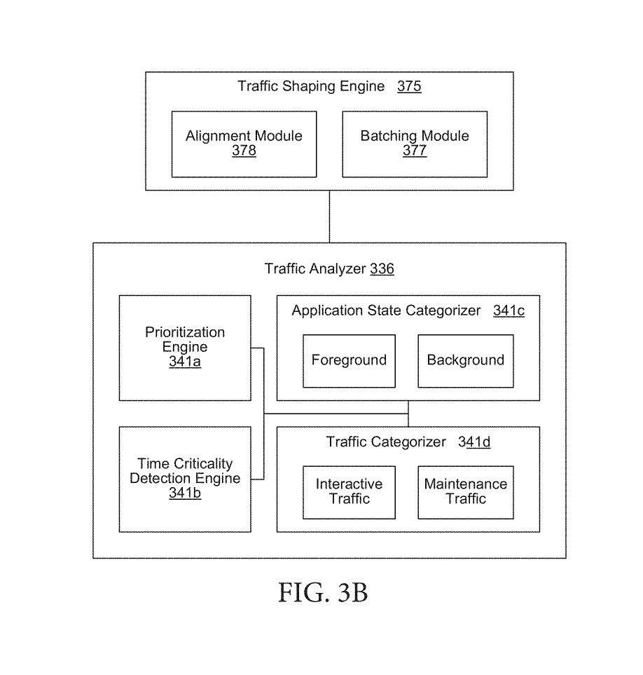

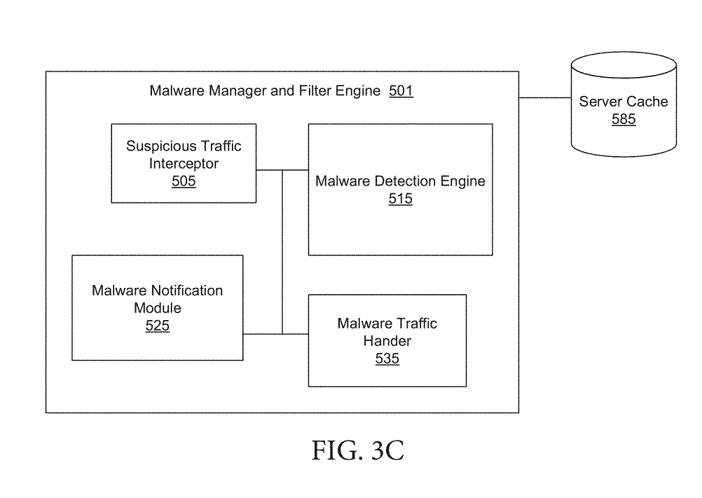

The mobile device 150 can include a local proxy (e.g., the local proxy 175, 275, as shown in the examples of FIG. 1C, FIG. 2A, and FIG. 3A). In one embodiment, the local proxy on the mobile device 150 can monitor outgoing and/or incoming traffic for various reasons including but not limited to malware detection, identification, and/or prevention.

In conjunction with monitoring traffic (e.g., by the traffic monitor engine 405 shown in the example of FIG. 2D), the information gathered can be used for detection of malicious traffic to/from the mobile device 150 (e.g., malware, etc.). The traffic monitor engine 405 can also gather information about traffic characteristics specific for the purposes of detecting malicious traffic.

For example, in monitoring traffic to/from the mobile device 150 (e.g., by the traffic monitor engine 405), the proxy can detect, track, analyze, and/or track patterns (e.g., timing patterns, location patterns, periodicity patterns, etc.) for use in malware detection, identification, and prevention. In tracking patterns, suspicious traffic patterns can be detected (e.g., by the suspicious traffic pattern detector 416) from one or more applications or services on the device 150.

Referring to FIG. 1A, traffic can be flagged (e.g., by the malware detection engine 415 shown in the example of FIG. 2D) as suspicious based on its timing characteristics (e.g., t1 113, t2 115, t3 117) including, time of day, frequency of occurrence, time interval between requests, etc. Timing characteristics can also be tracked relative to other requests/traffic made by the same application or other requests/traffic appearing to be made by the same application (e.g., application 108). For example, the time interval between t1 113, t2 115, and/or t3 117 may be determined and/or tracked over time. Certain criteria in the time interval across requests made by an application 108 may cause a particular traffic event to be identified as being suspicious.

Traffic can also be flagged as suspicious based on the target destination (e.g., by the suspicious destination detector 417 shown in the example of FIG. 2D). For example, in a request made by an application that appears to be connecting to Facebook 108 on the device 150 makes two requests to addressable entities on the Facebook server 103 and 105. However, the same application 108 is also detected to be making a request to entity 107 which does not appear to be a Facebook resource. The suspicious destination detector 417 (e.g., shown in the example of FIG. 2D) can identify suspicious destinations/origins or routing of requests based on the destination/origination identifier or a portion of the identifier (e.g., IP address, URI, URL, destination country, originating country, etc.) or identify suspicious destinations based on the application 108 making the request relative to the destination of the traffic and whether the destination would be expected according to the application/service 108 making or appearing to be making the request.

In response to identifying malware or detecting traffic that is potentially malicious, the proxy can generate a notification (e.g., by the malware notifier module 425 shown in the example of FIG. 2D). The notifier module 425 can notify the device (e.g., the operating system), the user (e.g., the user notifier 426), and/or the server 427 (e.g., the host server 100, 200, or proxy 325 in the examples of FIGS. 1B-1C and FIG. 3A, respectively) to determine how to handle the identified malware or detected traffic. The malware traffic handling engine 435 can subsequently handle the suspicious traffic according to OS, user, and/or server instructions.

For example, the user notifier 426 can notify the user that suspicious traffic has been detected and prompt whether the user wishes to allow the traffic. The notifier 426 can also identify the source (e.g., application/service 108) of the suspicious traffic for the user to take action or to instruct the proxy 375 (e.g., or the malware manager and filter engine 501 on the server side shown in the example of FIG. 3A) and/or the device operating system to take action. The notifier module 425 can also recommend different types of action to be taken by the user or device OS based on specific characteristics of the offending traffic (e.g., based on level of maliciousness or based on level of certainty that the offending traffic is in fact malware or other types of malicious software).

Alternatively, the local proxy 275 can implement malware traffic handling processes automatically without input from the OS, user, and/or server. For example, the malware traffic handling engine 435 (of the example shown in FIG. 2D) can block all incoming and/or outgoing suspicious traffic. The malware traffic handling engine 435 can also implement different handing procedures based on maliciousness and/or level of certainty that the suspicious traffic is in fact malicious. For example, timing patterns that are abnormal or that appear to fall out of the norm for an application by which a request appears to be generated. The type of information included in a request can indicate or flag malicious traffic (e.g., if the type of information includes user information, data, geolocation, browsing data, call records, etc.). A list of malware or malicious traffic identifiers and/or the associated applications can be compiled and updated (e.g., by the malware list manager 445) and stored in the local proxy.

The malware detection and filtering described herein may be performed solely on the local proxy 175 or 275, or solely by a proxy server 325 remote from the device 150, or performed by a combination of both the local proxy 275 and the proxy server 325. For example, the proxy server 325 can detect malware or otherwise suspicious traffic (e.g., by the malware detection engine 515) based on its own observations of incoming/outgoing traffic requests of the device 150 passing through the proxy server 325 (e.g., which generally resides on the server side of a distributed proxy and cache system such as that shown in the example of FIG. 1C). Based on various criteria (e.g., timing and/or origin/destination address), the malware detection engine 515 (shown in the example of FIG. 3C) can mark certain traffic as being malicious or potentially malicious. In addition, the identification of malicious traffic, malware, or potentially malicious traffic may be communicated to the proxy server 325 by the local proxy 275.

Either based on its own identification and/or identification of malware by the local proxy 275 communicated to the proxy 325, the proxy 325 can intercept the malicious or potentially malicious traffic (e.g., by the suspicious traffic interceptor 505), to block the traffic entirely or to hold the traffic from passing until verification that the traffic is not malicious. The proxy 325 can similarly notify various parties (e.g., by the malware notification module 525) when offensive traffic has been detected including but not limited to, mobile devices which have the same application as the one detected to generate offensive traffic, users, network providers, or third party applications/content providers in the event that a malicious resources is attempting to appear as a legitimate application.

The proxy server 325 can subsequently handle and manage malicious or potentially malicious traffic based on instructions received from one or more parties (e.g., by the malware traffic handler 535). For example, a network service provider may instruct the proxy server 325 to block all future traffic originating from or destined to a particular application for all mobile devices on their network. A specific user may instruct the proxy to allow the traffic, or the user may request additional information before making a decision on how to handle the malicious or potentially malicious traffic.

FIG. 1B illustrates an example diagram of a system where a host server 100 performs some or all of malware detection, identification, and prevention based on traffic observations.

The client devices 150 can be any system and/or device, and/or any combination of devices/systems that is able to establish a connection, including wired, wireless, cellular connections with another device, a server and/or other systems such as host server 100 and/or application server/content provider 110. Client devices 150 will typically include a display and/or other output functionalities to present information and data exchanged between among the devices 150 and/or the host server 100 and/or application server/content provider 110. The application server/content provider 110 can by any server including third party servers or service/content providers further including advertisement, promotional content, publication, or electronic coupon servers or services. Similarly, separate advertisement servers 120A, promotional content servers 120B, and/or e-Coupon servers 120C as application servers or content providers are illustrated by way of example.

For example, the client devices 150 can include mobile, hand held or portable devices, wireless devices, or non-portable devices and can be any of, but are not limited to, a server desktop, a desktop computer, a computer cluster, or portable devices, including a notebook, a laptop computer, a handheld computer, a palmtop computer, a mobile phone, a cell phone, a smart phone, a PDA, a Blackberry device, a Palm device, a handheld tablet (e.g., an iPad or any other tablet), a hand held console, a hand held gaming device or console, any smartphone such as the iPhone, and/or any other portable, mobile, hand held devices, or fixed wireless interface such as a M2M device, etc. In one embodiment, the client devices 150, host server 100, and application server 110 are coupled via a network 106 and/or a network 108. In some embodiments, the devices 150 and host server 100 may be directly connected to one another.

The input mechanism on client devices 150 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

Signals received or detected indicating user activity at client devices 150 through one or more of the above input mechanism, or others, can be used in the disclosed technology in acquiring context awareness at the client device 150. Context awareness at client devices 150 generally includes, by way of example but not limitation, client device 150 operation or state acknowledgement, management, user activity/behavior/interaction awareness, detection, sensing, tracking, trending, and/or application (e.g., mobile applications) type, behavior, activity, operating state, etc.

In addition to application context awareness as determined from the client 150 side, the application context awareness may also be received from or obtained/queried from the respective application/service providers 110 (by the host 100 and/or client devices 150).

The host server 100 can use, for example, contextual information obtained for client devices 150, networks 106/108, applications (e.g., mobile applications), application server/provider 110, or any combination of the above, to detect and/or prevent malware in the system or any of the client devices 150 (e.g., to satisfy application or any other request including HTTP request). In one embodiment, the data traffic is monitored by the host server 100 to satisfy data requests made in response to explicit or non-explicit user 103 requests and/or device/application maintenance tasks.

For example, in context of battery conservation, the device 150 can observe user activity (for example, by observing user keystrokes, backlight or screen status, or other signals via one or more input mechanisms, etc.) and alters device 150 behaviors. The device 150 can also request the host server 100 to alter the behavior for network resource consumption based on user activity or behavior.

In one embodiment, the malware detection, identification, and prevention is performed using a distributed system between the host server 100 and client device 150. The distributed system can include proxy server and cache components on the server side 100 and on the device/client side, for example, as shown by the server cache 135 on the server 100 side and the local cache 185 on the client 150 side.

Functions and techniques disclosed for malware detection, identification, and prevention in networks (e.g., network 106 and/or 108) and devices 150, reside in a distributed proxy and cache system. The proxy and cache system can be distributed between, and reside on, a given client device 150 in part or in whole and/or host server 100 in part or in whole. The distributed proxy and cache system is illustrated with further reference to the example diagram shown in FIG. 1C. Functions and techniques performed by the proxy and cache components in the client device 150, the host server 100, and the related components therein are described, respectively, in detail with further reference to the examples of FIGS. 2-3.

In one embodiment, client devices 150 communicate with the host server 100 and/or the application server 110 over network 106, which can be a cellular network and/or a broadband network. To facilitate overall traffic management between devices 150 and various application servers/content providers 110 to implement network (bandwidth utilization) and device resource (e.g., battery consumption), the host server 100 can communicate with the application server/providers 110 over the network 108, which can include the Internet (e.g., a broadband network).

In general, the networks 106 and/or 108, over which the client devices 150, the host server 100, and/or application server 110 communicate, may be a cellular network, a broadband network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, UDP, HTTP, DNS, FTP, UPnP, NSF, ISDN, PDH, RS-232, SDH, SONET, etc.

The networks 106 and/or 108 can be any collection of distinct networks operating wholly or partially in conjunction to provide connectivity to the client devices 150 and the host server 100 and may appear as one or more networks to the serviced systems and devices. In one embodiment, communications to and from the client devices 150 can be achieved by an open network, such as the Internet, or a private network, broadband network, such as an intranet and/or the extranet. In one embodiment, communications can be achieved by a secure communications protocol, such as secure sockets layer (SSL) or transport layer security (TLS).

In addition, communications can be achieved via one or more networks, such as, but not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G, 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

FIG. 1C illustrates an example diagram of a proxy and cache system distributed between the host server 100 and device 150 that can detect and/or filter malware or other malicious traffic based on traffic observations.

The distributed proxy and cache system can include, for example, the proxy server 125 (e.g., remote proxy) and the server cache, 135 components on the server side. The server-side proxy 125 and cache 135 can, as illustrated, reside internal to the host server 100. In addition, the proxy server 125 and cache 135 on the server-side can be partially or wholly external to the host server 100 and in communication via one or more of the networks 106 and 108. For example, the proxy server 125 may be external to the host server and the server cache 135 may be maintained at the host server 100. Alternatively, the proxy server 125 may be within the host server 100 while the server cache is external to the host server 100. In addition, each of the proxy server 125 and the cache 135 may be partially internal to the host server 100 and partially external to the host server 100. The application server/content provider 110 can be any server including third party servers or service/content providers further including advertisement, promotional content, publication, or electronic coupon servers or services. Similarly, separate advertisement servers 120A, promotional content servers 120B, and/or e-Coupon servers 120C as application servers or content providers are illustrated by way of example.

The distributed system can also include, in one embodiment, client-side components, including by way of example but not limitation, a local proxy 175 (e.g., a mobile client on a mobile device) and/or a local cache 185, which can, as illustrated, reside internal to the device 150 (e.g., a mobile device).

In addition, the client-side proxy 175 and local cache 185 can be partially or wholly external to the device 150 and in communication via one or more of the networks 106 and 108. For example, the local proxy 175 may be external to the device 150 and the local cache 185 may be maintained at the device 150. Alternatively, the local proxy 175 may be within the device 150 while the local cache 185 is external to the device 150. In addition, each of the proxy 175 and the cache 185 may be partially internal to the host server 100 and partially external to the host server 100.

For malware detection, identification, and prevention in a network (e.g., cellular or other wireless networks), characteristics of user activity/behavior and/or application behavior at a mobile device (e.g., any wireless device) 150 can be tracked by the local proxy 175 and communicated over the network 106 to the proxy server 125 component in the host server 100. The proxy server 125 which in turn is coupled to the application server/provider 110 performs monitoring and analysis of the behavior and information to detect potentially harmful applications.

In addition, the local proxy 175 can identify and retrieve mobile device properties, including one or more of, battery level, network that the device is registered on, radio state, or whether the mobile device is being used (e.g., interacted with by a user). In some instances, the local proxy 175 can delay, block, and/or modify data prior to transmission to the proxy server 125 when possible malware is detected, as will be further detailed with references to the description associated with the examples of FIGS. 2A-2D and 3A-3C.

Similarly, the proxy server 125 of the host server 100 can also delay, block, and/or modify data from the local proxy prior to transmission to the content sources (e.g., the application server/content provider 110) when possible malware is detected. The proxy server 125 can gather real time traffic information about traffic to/from applications for later use in detecting malware on the mobile device 150 or other mobile devices.

In general, the local proxy 175 and the proxy server 125 are transparent to the multiple applications executing on the mobile device. The local proxy 175 is generally transparent to the operating system or platform of the mobile device and may or may not be specific to device manufacturers. In some instances, the local proxy 175 is optionally customizable in part or in whole to be device specific. In some embodiments, the local proxy 175 may be bundled into a wireless model, a firewall, and/or a router.

In one embodiment, the host server 100 can in some instances utilize the store and forward functions of a short message service center (SMSC) 112, such as that provided by the network service provider, in communicating with the device 150 for malware detection. Note that SMSC 112 can also utilize any other type of alternative channel including USSD or other network control mechanisms. As will be further described with reference to the example of FIG. 3, the host server 100 can forward content or HTTP responses to the SMSC 112 such that it is automatically forwarded to the device 150 if available, and for subsequent forwarding if the device 150 is not currently available.

In general, the disclosed distributed proxy and cache system allows malware prevention, for example, by filtering suspicious data from the communicated data.

FIG. 2A depicts a block diagram illustrating an example of client-side components in a distributed proxy and cache system residing on a mobile device (e.g., wireless device) 250 in a wireless network (or broadband network) that can detect, identify, and prevent malware based on application behavior, user activity, and/or other indicators of malware. FIG. 2D depicts a block diagram illustrating additional components in the malware manager and filter engine 401 shown in the example of FIG. 2A.

The device 250, which can be a portable or mobile device (e.g., any wireless device), such as a portable phone, generally includes, for example, a network interface 208 an operating system 204, a context API 206, and mobile applications which may be proxy-unaware 210 or proxy-aware 220. The device 250 further includes a malware manager and filter engine 401 (described in detail in FIG. 2D). Note that although the device 250 is specifically illustrated in the example of FIG. 2A as a mobile device, such is not a limitation and that device 250 may be any wireless, broadband, portable/mobile or non-portable device able to receive, transmit signals to satisfy data requests over a network including wired or wireless networks (e.g., WiFi, cellular, Bluetooth, LAN, WAN, etc.).

The network interface 208 can be a networking module that enables the device 250 to mediate data in a network with an entity that is external to the host server 250, through any known and/or convenient communications protocol supported by the host and the external entity. The network interface 208 can include one or more of a network adaptor card, a wireless network interface card (e.g., SMS interface, WiFi interface, interfaces for various generations of mobile communication standards including but not limited to 2G, 3G, 3.5G, 4G, LTE, etc.), Bluetooth, or whether or not the connection is via a router, an access point, a wireless router, a switch, a multilayer switch, a protocol converter, a gateway, a bridge, a bridge router, a hub, a digital media receiver, and/or a repeater.

Device 250 can further include client-side components of the distributed proxy and cache system, which can include a local proxy 275 (e.g., a mobile client of a mobile device) and a cache 285. In one embodiment, the local proxy 275 includes a user activity module 215, a proxy API 225, a request/transaction manager 235, a caching policy manager 245 having an application protocol module 248, a traffic shaping engine 255, and/or a connection manager 265. The traffic shaping engine 255 may further include an alignment module 256 and/or a batching module 257, the connection manager 265 may further include a radio controller 266. The request/transaction manager 235 can further include an application behavior detector 236 and/or a prioritization engine 241, the application behavior detector 236 may further include a pattern detector 237 and/or and application profile generator 239. Additional or fewer components/modules/engines can be included in the local proxy 275 and each illustrated component.

In one embodiment, a portion of the distributed proxy and cache system for malware detection, identification, and prevention resides in or is in communication with device 250, including local proxy 275 (mobile client) and/or cache 285. The local proxy 275 can provide an interface on the device 250 for users to access device applications and services including email, IM, voice mail, visual voicemail, feeds, Internet, games, productivity tools, or other applications, etc.

The proxy 275 is generally application independent and can be used by applications (e.g., both proxy-aware and proxy-unaware applications 210 and 220 and other mobile applications) to open TCP connections to a remote server (e.g., the server 100 in the examples of FIGS. 1B-1C and/or server proxy 125/325 shown in the examples of FIG. 1B and FIG. 3A). In some instances, the local proxy 275 includes a proxy API 225 which can be optionally used to interface with proxy-aware applications 220 (or applications (e.g., mobile applications) on a mobile device (e.g., any wireless device)).

The applications 210 and 220 can generally include any user application, widgets, software, HTTP-based application, web browsers, video or other multimedia streaming or downloading application, video games, social network applications, email clients, RSS management applications, application stores, document management applications, productivity enhancement applications, etc. The applications can be provided with the device OS, by the device manufacturer, by the network service provider, downloaded by the user, or provided by others. It is applications 210 and/or 220 that are likely to contain some form of malware or be a potentially harmful application.

One embodiment of the local proxy 275 includes or is coupled to a context API 206, as shown. The context API 206 may be a part of the operating system 204 or device platform or independent of the operating system 204, as illustrated. The operating system 204 can include any operating system including but not limited to, any previous, current, and/or future versions/releases of Windows Mobile, Apple iOS, Android, Symbian, Palm OS, Brew MP, Java 2 Micro Edition (J2ME), Blackberry, etc.

The context API 206 may be a plug-in to the operating system 204 or a particular client/application on the device 250. The context API 206 can detect signals indicative of user or device activity, for example, sensing motion, gesture, device location, changes in device location, device backlight status, device screen status, keystrokes, clicks, activated touch screen, mouse click or detection of other pointer devices. The context API 206 can be coupled to input devices or sensors on the device 250 to identify these signals. Such signals can generally include input received in response to explicit user input at an input device/mechanism at the device 250 and/or collected from ambient signals/contextual cues detected at or in the vicinity of the device 250 (e.g., light, motion, piezoelectric, etc.).

In one embodiment, the user activity module 215 interacts with the context API 206 to identify, determine, infer, detect, compute, predict, and/or anticipate, characteristics of user activity on the device 250. Various inputs collected by the context API 206 can be aggregated by the user activity module 215 to generate a profile for characteristics of user activity. Such a profile can be generated by the user activity module 215 with various temporal characteristics. For instance, user activity profile can be generated in real-time for a given instant to provide a view of what the user is doing or not doing at a given time (e.g., defined by a time window, in the last minute, in the last 30 seconds, etc.), a user activity profile can also be generated for a ‘session’ defined by an application or web page that describes the characteristics of user behavior with respect to a specific task they are engaged in on the device 250, or for a specific time period (e.g., for the last 2 hours, for the last 5 hours).

Additionally, characteristic profiles can be generated by the user activity module 215 to depict a historical trend for user activity and behavior (e.g., 1 week, 1 mo., 2 mo., etc.). Such historical profiles can also be used to deduce trends of user behavior, for example, access frequency at different times of day, trends for certain days of the week (weekends or week days), user activity trends based on location data (e.g., IP address, GPS, or cell tower coordinate data) or changes in location data (e.g., user activity based on user location, or user activity based on whether the user is on the go, or traveling outside a home region, etc.) to obtain user activity characteristics. User activity characteristics and/or the associated user activity characteristics profile may be used in malware detection and/or for generating a device activity signature to be used for malware detection.

In one embodiment, user activity module 215 can detect and track user activity with respect to applications, documents, files, windows, icons, and folders on the device 250. For example, the user activity module 215 can detect when an application or window (e.g., a web browser or any other type of application) has been exited, closed, minimized, maximized, opened, moved into the foreground, or into the background, multimedia content playback, etc.

In one embodiment, characteristics of the user activity on the device 250 can be used to detect or identify potentially harmful applications (e.g., malware) operating on the device (e.g., mobile device or any wireless device), as explained in more detail in the context of FIG. 2D.

In addition, or in alternative, the local proxy 275 can communicate the characteristics of user activity at the device 250 to the remote device (e.g., host server 100 and 300 in the examples of FIGS. 1B-1C and FIG. 3A) and the remote device detects or identifies potentially harmful applications using the characteristics of the user activity.

One embodiment of the local proxy 275 further includes a request/transaction manager 235, which can detect, identify, intercept, process, and/or manage data requests initiated on the device 250, for example, by applications 210 and/or 220, and/or directly/indirectly by a user request. The information gathered by the request/transaction manager 235 is used to detect and identify potentially harmful applications (e.g., malware).

In one embodiment, the local proxy 275 includes an application behavior detector 236 to track, detect, observe, and/or monitor applications (e.g., proxy-aware and/or unaware applications 210 and 220) accessed or installed on the device 250. Application behaviors, or patterns in detected behaviors (e.g., via the pattern detector 237) of one or more applications accessed on the device 250 can be used by the local proxy 275 to detect and/or identify potentially harmful applications.

For example, the application behavior detector 236 may determine usage patterns of applications on the mobile device. As the application behavior detector 236 determines such usage patterns, it stores those usage patterns so that they can be compared against application behavior to determine whether an application may include malware or other potentially harmful code. The application behavior detector 236 may further update the usage patterns as new applications or usage patterns are associated with the mobile device.

For example, the application behavior detector 236 may detect when an application uploads data from the mobile device (i.e., an upload event). The application behavior detector 236 may detect anomalies in an upload event, such as: (1) the application's upload event including more data than the application's download event; (2) the application's upload event using APIs that are intended for reporting data; (3) the frequency of the application's upload events; (4) the size of the application's upload events; (5) the destination(s) of the application's upload events; (6) upload events that occur immediately after or within a period of time after installing/initializing the application; and (7) data patterns within one or more of the application's upload events. The application behavior detector 236 may monitor an application's data transfer that occurs while the application is in various states (e.g., the application is in the background, the application is in the foreground). The application behavior detector 236 may detect when an application responds to being killed by the operating system by either attempting to avoid being killed or by restarting after being killed. The application behavior detector 236 may detect anomalies relating to the user's privacy, such as: (1) when an application attempts to or acquires certain permissions; (2) when an application accesses activities of other applications; and (3) when an application performs actions that are inconsistent with the user's privacy expectations.

In one embodiment, the pattern detector 237 can detect recurrences in application requests made by the multiple applications, for example, by tracking patterns in application behavior. A tracked pattern can include detecting that certain applications, as a background process, poll an application server regularly, at certain times of day, on certain days of the week, periodically in a predictable fashion, with a certain frequency, with a certain frequency in response to a certain type of event, in response to a certain type user query, frequency that requested content is the same, frequency with which a same request is made, interval between requests, applications making a request, or any combination of the above, for example.

Such recurrences can be used by malware manager and filter engine 401 to detect when an application is sending or receiving data in a manner that is out of the ordinary (e.g., data that is larger or smaller than normal; requests that are larger than normal, requests that occur at a time that is out of the ordinary, etc.) such that the application may be operating as malware.

The connection manager 265 in the local proxy (e.g., the heartbeat manager 267) can detect, identify, and intercept any or all heartbeat (keep-alive) messages being sent from applications. The presence or absence of heartbeat messages can be used by malware manager and filter engine 401 to detect when an application is operating in a manner that is out of the ordinary (e.g., sending more or fewer heartbeats than expected) such that the application may be operating as malware.

The local proxy 275 generally represents any one or a portion of the functions described for the individual managers, modules, and/or engines. The local proxy 275 and device 250 can include additional or fewer components; more or fewer functions can be included, in whole or in part, without deviating from the novel art of the disclosure.

FIG. 2B depicts a block diagram illustrating a further example of components in the cache system shown in the example of FIG. 2A, which is capable of caching and adapting caching strategies for mobile application behavior and/or network conditions.

In one embodiment, the caching policy manager 245 includes a metadata generator 203, a cache look-up engine 205, a cache appropriateness decision engine 246, a poll schedule generator 247, an application protocol module 248, a cache or connect selection engine 249 and/or a local cache invalidator 244. The cache appropriateness decision engine 246 can further include a timing predictor 246a, a content predictor 246b, a request analyzer 246c, and/or a response analyzer 246d, and the cache or connect selection engine 249 includes a response scheduler 249a. The metadata generator 203 and/or the cache look-up engine 205 are coupled to the cache 285 (or local cache) for modification or addition to cache entries or querying thereof.

The cache look-up engine 205 may further include an ID or URI filter 205a, the local cache invalidator 244 may further include a TTL manager 244a, and the poll schedule generator 247 may further include a schedule update engine 247a and/or a time adjustment engine 247b. One embodiment of caching policy manager 245 includes an application cache policy repository 243. In one embodiment, the application behavior detector 236 includes a pattern detector 237, a poll interval detector 238, an application profile generator 239, and/or a priority engine 241. The poll interval detector 238 may further include a long poll detector 238a having a response/request tracking engine 238b. The poll interval detector 238 may further include a long poll hunting detector 238c. The application profile generator 239 can further include a response delay interval tracker 239a.

The pattern detector 237, application profile generator 239, and the priority engine 241 were also described in association with the description of the pattern detector shown in the example of FIG. 2A. One embodiment further includes an application profile repository 242 which can be used by the local proxy 275 to store information or metadata regarding application profiles (e.g., behavior, patterns, type of HTTP requests, etc.)

Periodicity can be detected, by the decision engine 246 or the request analyzer 246c, when the request and the other requests generated by the same client occur at a fixed rate or nearly fixed rate, or at a dynamic rate with some identifiable or partially or wholly reproducible changing pattern. If the requests are made with some identifiable pattern (e.g., regular intervals, intervals having a detectable pattern, or trend (e.g., increasing, decreasing, constant, etc.) the timing predictor 246a can determine that the requests made by a given application on a device is predictable and use that in determining whether an application is potentially harmful.

An identifiable pattern or trend can generally include any application or client behavior which may be simulated either locally, for example, on the local proxy 275 on the mobile device 250 or simulated remotely, for example, by the proxy server 325 on the host 300, or a combination of local and remote simulation to emulate application behavior.

In one embodiment, the decision engine 246, for example, via the response analyzer 246d, can collect information about a response to an application or client request generated at the mobile device 250. The response is typically received from a server or the host of the application (e.g., mobile application) or client which sent the request at the mobile device 250. In some instances, the mobile client or application can be the mobile version of an application (e.g., social networking, search, travel management, voicemail, contact manager, email) or a web site accessed via a web browser or via a desktop client.

In one embodiment, the timing predictor 246a determines the timing characteristics of a given application (e.g., mobile application) or client from, for example, the request/response tracking engine 238b and/or the application profile generator 239 (e.g., the response delay interval tracker 239a). Using the timing characteristics, the timing predictor 246a determines whether the content received in response to the requests is expected.

In some instances, the timing characteristics of a given request type for a specific application, for multiple requests of an application, or for multiple applications can be stored in the application profile repository 242. The application profile repository 242 can generally store any type of information or metadata regarding application request/response characteristics including timing patterns, timing repeatability, content repeatability, etc.

The application profile repository 242 can also store metadata indicating the type of request used by a given application (e.g., long polls, long-held HTTP requests, HTTP streaming, push, COMET push, etc.) Application profiles indicating request type by applications can be used when subsequent same/similar requests are detected, or when requests are detected from an application which has already been categorized. In this manner, timing characteristics for the given request type or for requests of a specific application which has been tracked and/or analyzed, need not be reanalyzed.

Application profiles can be associated with a time-to-live (e.g., or a default expiration time). The use of an expiration time for application profiles, or for various aspects of an application or request's profile can be used on a case by case basis. The time-to-live or actual expiration time of application profile entries can be set to a default value or determined individually, or a combination thereof. The expiration of application profiles allows for the system to keep up-to-date profiles of applications so that new malware can be detected. Application profiles can also be specific to wireless networks, physical networks, network operators, or specific carriers.

One embodiment includes an application blacklist manager 201. The application blacklist manager 201 can be coupled to the application cache policy repository 243 and can be partially or wholly internal to local proxy or the caching policy manager 245. Similarly, the blacklist manager 201 can be partially or wholly internal to local proxy or the application behavior detector 236. The blacklist manager 201 can aggregate, track, update, manage, adjust, or dynamically monitor a list of applications and/or destinations of servers/host that are “blacklisted,” or identified as being malware, potentially being malware, being indicative of malware, being associated with malware, or of being any other type of potentially harmful application. The blacklist of destinations, when identified in a request, can potentially be used to allow the request to be sent over the (cellular) network for servicing. Additional processing on the request may not be performed since it is detected to be directed to a blacklisted destination.

Blacklisted destinations can be identified in the application cache policy repository 243 by address identifiers including specific URIs or patterns of identifiers including URI patterns. In general, blacklisted destinations can be set by or modified for any reason by any party including the user (owner/user of mobile device 250), operating system/mobile platform of device 250, the destination itself, network operator (of cellular network), Internet service provider, other third parties, or according to a list of destinations for applications known to be uncacheable/not suited for caching. Some entries in the blacklisted destinations may include destinations aggregated based on the analysis or processing performed by the local proxy (e.g., cache appropriateness decision engine 246).

For example, applications or mobile clients on the mobile device that have been identified as potentially malware or other potentially harmful applications can be added to the blacklist. Their corresponding hosts/servers may be added in addition to or in lieu of an identification of the requesting application/client on the mobile device 250. Some or all of such clients identified by the system can be added to the blacklist. For example, for all application clients or applications that are identified as being potentially malware or other potentially harmful applications, only those with certain detected characteristics (based on timing, periodicity, frequency of response content change, content predictability, size, etc.) may be blacklisted.

The blacklisted entries may include a list of requesting applications or requesting clients on the mobile device (rather than destinations) such that, when a request is detected from a given application or given client, it may be blocked or otherwise processed before being sent to protect the mobile device from the potentially harmful code in the application.

The local proxy 275, upon receipt of an outgoing request from its mobile device 250 or from an application or other type of client on the mobile device 250, can intercept the request and determine whether the request indicates that the requesting application may be malware or another type of potentially harmful application.

In one embodiment, the time interval is determined based on request characteristics (e.g., timing characteristics) of an application on the mobile device from which the outgoing request originates. For example, poll request intervals (e.g., which can be tracked, detected, and determined by the long poll detector 238a of the poll interval detector 238) can be used to determine the time interval to wait before responding to a request with a local cache entry and managed by the response scheduler 249a.

In one embodiment, the response/request tracking engine 238b can track requests and responses to determine, compute, and/or estimate, the timing diagrams for application or client requests.

For example, the response/request tracking engine 238b detects a first request (Request 0) initiated by a client on the mobile device and a second request (Request 1) initiated by the client on the mobile device after a response is received at the mobile device responsive to the first request. The second request is one that is subsequent to the first request.

In one embodiment, the response/request tracking engine 238b can track requests and responses to determine, compute, and/or estimate the timing diagrams for application or client requests. The response/request tracking engine 238b can detect a first request initiated by a client on the mobile device and a second request initiated by the client on the mobile device after a response is received at the mobile device responsive to the first request. The second request is one that is subsequent to the first request.

The response/request tracking engine 238b further determines relative timings between the first, second requests, and the response received in response to the first request. In general, the relative timings can be used by the long poll detector 238a to determine whether requests generated by the application are long poll requests.

FIG. 2C depicts a block diagram illustrating examples of additional components in the local proxy 275 shown in the example of FIG. 2A which is further capable of performing malware detection, identification, and prevention based on application behavior and/or user activity.

In this embodiment of the local proxy 275, the user activity module 215 further includes one or more of, a user activity tracker 215a, a user activity prediction engine 215b, and/or a user expectation manager 215c. The application behavior detector 236 can further include a prioritization engine 241a, a time criticality detection engine 241b, an application state categorizer 241c, and/or an application traffic categorizer 241d. The local proxy 275 can further include a backlight detector 219 and/or a network configuration selection engine 251. The network configuration selection engine 251 can further include, one or more of, a wireless generation standard selector 251a, a data rate specifier 251b, an access channel selection engine 251c, and/or an access point selector.

In one embodiment, mobile or wireless traffic can be categorized as interactive traffic (i.e., the user is actively waiting for a response) or background traffic (i.e., the user is not expecting a response). This categorization can be used in conjunction with (or in lieu of) a second type of categorization of traffic: immediate, low priority, and immediate if the requesting application is in the foreground and active.

In one embodiment, the application behavior detector 236 is able to detect, determine, identify, or infer the activity state of an application on the mobile device 250 to which traffic has originated from or is directed to, for example, via the application state categorizer 241c and/or the traffic categorizer 241d. The activity state can be determined by whether the application is in a foreground or background state on the mobile device (via the application state categorizer 241c) since the traffic for a foreground application vs. a background application may be handled differently.

In one embodiment, the activity state can be determined, detected, identified, or inferred with a level of certainty of heuristics, based on the backlight or screen status of the mobile device 250 (e.g., by the backlight detector 219) or other software agents or hardware sensors on the mobile device, including but not limited to, resistive sensors, capacitive sensors, ambient light sensors, motion sensors, touch sensors, etc. In general, if the backlight or screen is on, the traffic can be treated as being or determined to be generated from an application that is active or in the foreground, or the traffic is interactive. In addition, if the backlight or screen is on, the traffic can be treated as being or determined to be traffic from user interaction or user activity, or traffic containing data that the user is expecting within some time frame.

In one embodiment, the activity state is determined based on whether the traffic is interactive traffic or maintenance traffic. Interactive traffic can include transactions from responses and requests generated directly from user activity/interaction with an application and can include content or data that a user is waiting or expecting to receive. Maintenance traffic may be used to support the functionality of an application which is not directly detected by a user. Maintenance traffic can also include actions or transactions that may take place in response to a user action, but the user is not actively waiting for or expecting a response.

In the alternate or in combination, the activity state can be determined from assessing, determining, evaluating, inferring, or identifying user activity at the mobile device 250 (e.g., via the user activity module 215). For example, user activity can be directly detected and tracked using the user activity tracker 215a. The user activity and the data traffic resulting from the user activity can then be categorized appropriately for subsequent processing to determine whether the application is a potentially harmful application. Furthermore, user activity can be predicted or anticipated by the user activity prediction engine 215b. By predicting user activity or anticipating user activity, the user activity and/or the data traffic resulting from that user activity that occurs after the prediction can be analyzed to determine the variance of the actual activity from the predicted activity, with a large variance being an indicator that the mobile application is a potentially harmful application.

FIG. 2D depicts a block diagram illustrating additional components in the malware manager and filter engine shown in the example of FIG. 2A.

In one embodiment, the malware manager and filter engine 401 of the local proxy 275 includes a traffic monitor engine 405, a malware detection engine 415 having a suspicious traffic pattern detector 416 and/or a suspicious destination detector 417, a malware notifier module 425 having a user notifier 426 and/or a server notifier 427, a malware traffic handling engine 435, and/or a malware list manager 445. As described in detail in association with FIG. 1A, the malware detection engine 415 is able to use traffic patterns (e.g., as detected by the suspicious traffic pattern detector 416) to identify malicious incoming/outgoing traffic or otherwise potentially malicious. Traffic patterns can include timing of requests, time interval of requests (e.g., by the suspicious pattern detector 416), destination/origin of requests (e.g., by the suspicious destination detector 417), the data sent/received in the traffic, any processes performed in advance of or as a result of the traffic event.

As explained above, malware and/or potentially harmful applications can be identified by analyzing an application's or a device's data traffic patterns and/or other behavior characteristics to determine whether the application is potentially spying on a user or otherwise inappropriately tracking user data/behavior. The analysis described herein may use data traffic signature-based malware protection or device activity signature-based malware protection.

The data traffic that software code creates over time when it executes can be translated into a data traffic signature associated with a particular computing device, such as a mobile phone. Similarly, the activity of the device that occurs as a result of the software code executing over time can be translated into a device activity signature associated with the device. This data traffic signature and/or the device activity signature can be compared with signatures of other similar devices or with future signatures from the same device to determine whether an application is malware or a potentially harmful application.

The traffic monitor engine 405 monitors data traffic (both incoming and outgoing) on the mobile device. The traffic monitor engine 405 detects data traffic of a mobile application on the mobile device. In one embodiment, the traffic monitor engine 405 detects characteristics of behavior of the mobile application. Based on the monitored traffic, the malware manager and filter engine 401 creates a data traffic signature that can be used for malware detection. The signature may be updated as new applications or usage patterns are associated with the device. For example, a download of a new known application may generate an additional traffic pattern that is incorporated into the signature.

The malware detection engine 415 analyzes the monitored traffic to detect signs of malware, using a suspicious traffic pattern detector 416 and/or a suspicious destination detector 417. In one embodiment, the malware detection engine 415 identifies one or more indicators that the mobile application is a potentially harmful application and determines, based on an analysis of the one or more indicators, whether the mobile application is a potentially harmful application. The one or more indicators are identified based on the data traffic of the mobile application and the characteristics of behavior of the mobile application.

The suspicious traffic pattern detector 416 may account for expected changes in traffic patterns, such as (1) an increase in traffic associated with a specific application that is correlated with increased user screen time for that application; (2) a gradual increase in traffic over time from an application; and (3) new types of activity, such as the use of a new port by an application.

In one embodiment, malware detection engine 415 may determine that an application may be a potentially harmful application when the application's upload event includes a larger data set during uplink transmissions (i.e., from the mobile device to a server) than during downlink transmissions (i.e., from a server to the mobile device).

In one embodiment, malware detection engine 415 may determine that an application may be a potentially harmful application when the application's upload event uses APIs that are intended for reporting data (e.g., Google Analytics for Firebase).

In one embodiment, malware detection engine 415 may determine that an application may be a potentially harmful application based on the frequency of an application's uploads. The suspicious traffic pattern detector 416 detects patterns in the application's upload frequency (e.g., based on the time-of-day of uploads, day-of-the-week of uploads, or more complex time series of uploads).

In another embodiment, malware detection engine 415 may determine that an application may be a potentially harmful application based on patterns in the application's uploads. For example, the suspicious traffic pattern detector 416 may detect that the application's uploads include a data field that contains a constant data value across multiple uploads for a particular user, but contains a different value across multiple uploads for a different user. Such a pattern in upload data can be an indicator that an application has assigned a user identifier to a user for potentially tracking user behavior.

In one embodiment, malware detection engine 415 may determine that an application may be a potentially harmful application based on the size of the application's uploads (e.g., large upload sizes may indicate that the application is maliciously reporting a user's data).

In one embodiment, suspicious destination detector 417 may compare one or more destination(s) of an application's uploads to a list of known suspicious destinations to determine whether an application may be a potentially harmful application. A list of known suspicious destinations may be maintained by malware list manager 445, or it may be maintained by the suspicious destination detector 417.

Malware list manager 445 may identify known suspicious destinations a number of ways. When the malware detection engine 415 detects that an application is a potentially harmful application, the malware list manager 445 adds that application and/or any destinations associated with that application to the list. In addition, the malware list manager 445 may communicate with a remote proxy, a host server, a back-end server, or a third-party service provider to maintain an updated list of malware and/or associated destinations. The remote proxy, host server, back-end server, or the third-party provider may identify malware and/or associated destinations (i.e., known destinations) using machine learning or other types of offline analysis. The machine learning or offline analysis to identify known destinations can be performed by one or more remote cloud servers that communicate with the mobile device and, possibly, many other mobile device operating in the network.

The suspicious destination detector 417 may identify suspicious destinations in ways other than using a list (e.g., a list from malware list manager 445). For example, uploads that include more than one destination may indicate that the application may be a potentially harmful application. The multiple destinations can include, for example, Internet destinations that are known or suspected to be associated with malware, cloud servers that are known or suspected to be associated with malware, or any other destination(s) that would not otherwise be expected to be an upload destination given the context of the application and its upload behavior. The suspicious destination detector 417 may also detect when an application uses APIs that would not otherwise be expected or that themselves use suspicious destinations.

As explained above, the application behavior detector 236 can determine an application's state and other behavior. The traffic monitor engine 405 can monitor an application's data transfers that occur while the application is in various states (e.g. background, foreground but not in interactive use), and, in one embodiment, the malware detection engine 415 can use that information to determine whether the application is malware or a potentially harmful application. For example, a data transfer from an application, such as an upload of data, while the application is in the background or is not in interactive use, may indicate that the application is a potentially harmful application.

The application behavior detector 236 may also determine and/or track when an application was installed. In one embodiment, the malware detection engine 415 can use information about when the application was installed along with information from the traffic monitor engine 405 about the application's upload activity to detect uploads that take place either immediately after or within a period of time after the application has been installed or initialized to detect a potentially harmful application. The period of time within which the malware detection engine 415 can detect uploads after installation/initialization can be a specific amount of time, or it can be an amount of time that varies based on the behavior of the application and/or the user. By identifying immediate or nearly immediate data uploads, the malware detector can identify applications that attempt to collect a small amount of data from a user upon installation of the application before the user has a chance to uninstall and/or deactivate the application.

In another embodiment, the malware detection engine 415 can determine that an application is malware or a potentially harmful application based on the application operating in the background. For example, regardless of whether the application is actively uploading data, if it is operating in the background, it may be tracking user behavior and/or storing data for later upload.

In other embodiments, the application behavior detector 236 may detect other application activities that may indicate that the application is malware or a potentially harmful application. For example, if the application behavior detector 236 detects that an application performs one or more actions to avoid being killed by the operating system when the operating system attempts to free up memory or clean up unused applications, the malware detection engine 415 may determine that the application is tracking user behavior. If the application behavior detector 236 detects that an application restarts itself after being killed by the operating system, the malware detection engine 415 may determine that the application is tracking user behavior. If the application behavior detector 236 detects that an application performs one or more actions or other activities that could prevent the application from being considered inactive by the operating system (e.g., so that the application appears active to the operating system), the malware detection engine 415 may determine that the application is tracking user behavior.

The application behavior detector 236 detects when an application seeks and/or acquires certain permissions, and, in one embodiment, the malware detection engine 415 uses that information to determine that an application is malware or another type of potentially harmful application. For example, the malware detection engine 415 may determine that permissions that give the application the ability to determine which application is in the foreground, to retrieve user information, to access contacts and/or calendar, and/or to determine a user's location (either at a coarse level or a fine level) indicate that the application is malware or another type of potentially harmful application.

The application behavior detector 236 detects when an application performs actions that require a user's permission and/or require a disclosure to the user but that do not actually receive the user's permission or do not make the required disclosure to the user, and, in one embodiment, the malware detection engine 415 uses that information to determine that an application is malware or another type of potentially harmful application.

In one embodiment, application behavior detector 236 detects when a first application accesses the activities of other applications, and malware detection engine 415 uses that information to determine that the first application is a potentially harmful application. For example, application behavior detector 236 can detect when an application has the ability to and/or does access another application's activities, or when an application has the ability to and/or does observe what another application draws and/or shows on the screen of a mobile device (e.g., take screenshots), or when an application has the ability to and/or does observe another application's network traffic (e.g., metadata of network traffic, data of network traffic).

In one embodiment, the malware detection engine 415 monitors the frequency and/or other patterns of activity that occurs in the background, and based on that information, determines that the application may be a potentially harmful application. For example, an application's use of APIs and/or other routines that allow for application wake-up in the background without performing an activity that would otherwise be expected can be used as an indicator that an application is tracking user behavior. One such example of an application performing a wake-up or other similar action for a background fetch, without accessing the network, can be considered an activity that lacks the expected activity (i.e., network access).

In one embodiment, malware detection engine 415 analyzes a privacy policy associated with an application to determine that the application may be malware or another type of potentially harmful application. For example, malware detection engine 415 identifies topics within a privacy policy that may indicate that an application is tracking user behavior. This information can be used as an indicator that an application developer assumes that users do not read the privacy policy and, therefore, unintentionally give legal permission to track the user's behavior. In addition, malware detection engine 415 can further compare topics from the privacy policy associated with the application to the actual operation and/or activity of the application (e.g., permissions requested and/or granted, application activity, data uploads by the application) to identify discrepancies between the privacy policy and the corresponding application behavior. In one embodiment, the analysis of the privacy policy may occur at a server or other back-end computing device, with the results being transmitted over a network to the malware detection engine 415.

The above types of information and/or behaviors that are used to detect or identify malware or other types of potentially harmful applications may be referred to as indicators. One or more indicators may be flagged as part of the analysis. In various embodiments, malware detection engine 415 and malware manager and filter engine 401 can be configured such that the presence of one indicator does not trigger a warning that an application may be a potentially harmful application but the presence of multiple indicators, together, does trigger such a warning. Conversely, malware detection engine 415 and malware manager and filter engine 401 can be configured such that the presence of a single indicator does trigger a warning that an application may be a potentially harmful application. The number of indicators needed to trigger a warning can be customized, for example, by a user, by an application developer, or by a third party running a communal marketplace (e.g., Google Play Store, Apple App Store, or Apple iTunes Store). Further, malware detection engine 415 and malware manager and filter engine 401 can be configured such that multiple indicators being present at the same time (e.g., frequency of uploads while the application is in the background, and the application's background activity within 24 hours of being installed) triggers a warning, or it can be configured such that multiple indicators being present independently (e.g., background uploads and large uploads in foreground) triggers a warning. Further, malware detection engine 415 and malware manager and filter engine 401 can be configured such that the indicators are arranged/grouped in a hierarchy or other type of priority classification, so that the presence of indicators within one or more hierarchy level can lower the threshold for triggering a warning resulting from the presence of indicators within one or more other hierarchy levels. For example, the presence of uploads while an application is in the background may lower the triggering threshold based on the presence of uploads of varying frequency, size, destination, etc.

In one embodiment, third-party services can be used to provide one or more of the indicators that identify an application as a potentially harmful application. For example, the malware manager and filter engine 501 of proxy server 325 of host server 300 (as shown in FIG. 3A) may perform some or all of the analysis discussed above and provide the results to the malware manager and filter engine 401 for handling.

In one embodiment, the flags and/or thresholds used by malware detection engine 415 and malware manager and filter engine 401 to trigger an indicator are configurable. They can be configured by a user, by an application developer, or by a third party running a communal application marketplace (e.g., Google Play Store, Apple App Store, or Apple iTunes Store). Alternatively, they can be configured using machine learning. For example, the flags and/or thresholds can use supervised learning against known malware or malware flags by one or more other malware tracking mechanisms or defined by offline analysis. Some examples of the methods and/or models that can be used to machine-learn the flags and/or thresholds include, for example, support vector machines, linear regression, logistic regression, naïve Bayes classifiers, linear discriminant analysis, decision trees, k-nearest neighbor algorithms, and/or neural networks. Additionally, the flags and/or thresholds can be machine-learned using unsupervised learning to identify important features and/or flags that characterize different malware types, which can be used to define important features and/or hierarchies using principal component analysis, clustering, and/or neural networks. The machine learning to identify flags and/or thresholds can be performed by one or more remote cloud servers that communicate with the mobile device.

In one embodiment, malware detection engine 415, as part of analyzing data traffic and/or device activity/behavior, can perform flagging of indicators on a number of different bases. For example, flagging of indicators can be performed on a user-by-user basis or on an application-by-application basis. Flagging of an application as malware can be based on the application getting flagged because a user count or user density (e.g., within a population that can be global, certain geography, certain device model, operating system, or other feature that can be used to segment the population) crosses a threshold. The threshold can be either manually defined or machine-learned, and it can be specified to balance the competing interests of sensitivity and avoidance of false alarms. User-by-user analysis can be performed at the device, or it can be performed by a server, or partly by both.

In one embodiment, flagging can be performed across a user population, for example, by using a user identifier, either by partially processing data on each device and evaluating patterns across devices on a server/network side, or the device providing raw data entries to the server and server processing them to find patterns.

In one embodiment, flagging of indicators can be considered version-specific (e.g., affecting a specific version of an application only) or can apply to all versions, or a subset of versions, of an application. Having one or more versions of an application flagged can be used as an identifier for other versions of the application, including past versions.

In one embodiment, the checking for flags and/or evaluation of indicators for an application to determine if the application is a potentially harmful application can be performed upon installation of the application, shortly after installation of the application, or periodically while the application is installed. It can be triggered by a change in one or more of the indicators, or at any other time. The evaluation can be performed on user devices in production, on user devices in a dedicated test group, on user devices in a lab, or on simulated user devices.

In one embodiment, the processing required for analyzing data traffic and/or device activity/behavior can be performed locally on a mobile device (as described in the context of FIG. 2), remotely by one or more cloud servers, or in any combination by dividing the processing between a mobile device and the remote server(s). For example, raw information associated with the data traffic and/or device activity/behavior can be uploaded by a mobile device to the remote cloud server(s) that can then perform data-intensive processing using mathematical analysis, statistical analysis, or machine learning or other types of artificial intelligence to analyze the data and identify indicators and determine whether and application is a potentially harmful application. The cloud server(s) can then communicate with the mobile device to provide the mobile device with the results of the analysis and instruct the mobile device how to handle the potentially harmful application. In the situation where the processing is shared between the mobile device and the cloud server(s), the mobile device and the cloud server(s) can use different processing techniques and/or algorithms to analyze the data, given their different available processing resources and power constraints. The mobile device can perform different types and/or levels of analysis based on whether and how much additional processing support is available from the cloud server(s). For example, when the cloud server(s) are unavailable (e.g., because the mobile device is offline, because the network is congested, or because a potentially harmful application is already interfering with or blocking the mobile device's network activity), the mobile device can perform the processing locally.

In one embodiment, when some or all of the processing required for analyzing data traffic and/or device activity/behavior to identify indicators and determine whether and application is a potentially harmful application is performed by one or more remote cloud servers, the cloud server(s) can use in their processing data that has been aggregated from uploads from multiple devices. For example, raw information uploaded from a population of mobile devices can be more useful in detecting a potentially harmful application than just the information uploaded from a single mobile device analyzed in isolation. When using information aggregated from many mobile devices, the cloud server(s) can identify global patterns of device activity/behavior that would not otherwise be apparent. The aggregated data can be used as inputs into the mathematical analysis, statistical analysis, or machine learning or other types of artificial intelligence to analyze the data and identify indicators and determine whether and application is a potentially harmful application.

In one embodiment, when the logic for the malware detector is stored and/or operated on the device (such as malware detection engine 415), the logic may be updated remotely. For example, as the algorithms and analysis used to detect a potentially harmful application become more complex and more intelligent, updates can be pushed to a mobile device to update the mobile device's local processing logic. Similarly, when the remote cloud server(s) collect more raw data that is used for the analysis, patterns, trends, or other indicators from the data can be pushed to a mobile device to update the mobile device's local processing logic (such as the malware manager and filter engine 401).

In one embodiment, past data of or relating to indicators may be stored to allow reprocessing when the logic and/or algorithms of the malware detection engine 415 are updated. The past data may be stored either locally on a mobile device or remotely at one or more cloud servers, or both.

Once the malware detection engine 415 has detected a potentially harmful application, the malware traffic handling engine 435 can block the application's traffic entirely or handle the application and/or traffic according to certain criteria. The notifier module 425 can notify a user, network provider, application server, or the host server of the potentially harmful application and receive input from one or more of these parties to determine how to handle the application and/or its traffic, for example. The malware list manager 445 can compile, aggregate, revise, and update a list of detected malware or other potentially harmful applications.

The malware manager and filter engine 401 can be coupled to a local cache 485 as shown or internally include the local cache 485 in part or in whole. The malware manager and filter engine 401 may further include, in part or in whole, the components shown herein on the server side of the engine 501 of FIG. 3A and FIG. 3C including, for example, one or more of, a traffic monitor engine, a malware detection engine having a suspicious traffic pattern detector and/or a suspicious destination detector, a malware notifier module having a user notifier and/or a server notifier, a malware traffic handling engine, and/or a malware list manager.

In some instances, some or all of the components in the malware manager and filter engine 501 on the server side may be separate from the local proxy 275 residing on the mobile device 250 and 350 of FIG. 2 and FIG. 3. For example, the mobile device 250 may include both proxy 275 and the proxy 325. The components including the traffic monitor engine 405, the malware detection engine 415 having the suspicious traffic pattern detector 416 and/or the suspicious destination detector 414, the malware notifier module 425 having the user notifier 426 and/or the server notifier 427, the malware traffic handling engine 435, and/or the malware list manager 445 or the associated functionalities can reside in the proxy 325 as shown or partially reside in the proxy 275 (e.g., for use with the request/transaction manager 235 and/or the application behavior detector 236) in addition to the components in 445 or in lieu of. In other words, in the event that proxies 275 and 325 are distinct proxies on a given device, they can include some or all of the same components/features. Additional or fewer components, modules, agents, and/or engines can be included in the local proxy 275 or the malware manager and filter engine 401 and each illustrated component.

FIG. 3A depicts a block diagram illustrating an example of server-side components in a distributed proxy and cache system residing on a host server 300 that manages traffic in a wireless network for resource conservation. The server-side proxy (or proxy server 325) can further categorize mobile traffic and/or implement delivery policies based on application behavior, content priority, user activity, and/or user expectations. FIG. 3C depicts a block diagram illustrating additional components in the malware manager and filter engine 501 shown in the example of FIG. 3A.

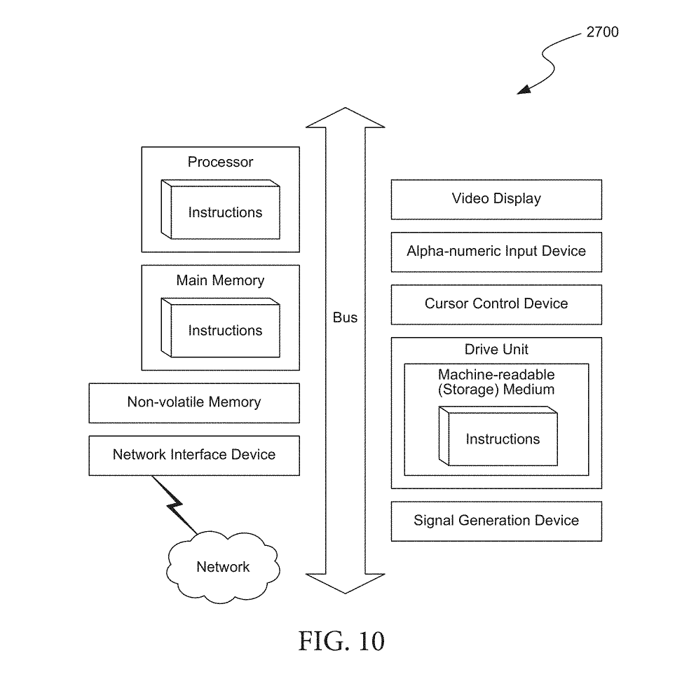

The host server 300 generally includes, for example, a network interface 308 and/or one or more repositories 312, 314, and 316. Note that server 300 may be any portable/mobile or non-portable device, server, cluster of computers and/or other types of processing units (e.g., any number of a machine shown in the example of FIG. 10) able to receive or transmit signals to satisfy data requests over a network including any wired or wireless networks (e.g., WiFi, cellular, Bluetooth, etc.).

The network interface 308 can include networking module(s) or devices(s) that enable the server 300 to mediate data in a network with an entity that is external to the host server 300, through any known and/or convenient communications protocol supported by the host and the external entity. Specifically, the network interface 308 allows the server 300 to communicate with multiple devices including mobile phone devices 350 and/or one or more application servers/content providers 310.

The host server 300 can store information about connections (e.g., network characteristics, conditions, types of connections, etc.) with devices in the connection metadata repository 312. Additionally, any information about third party application or content providers can also be stored in the repository 312. The host server 300 can store information about devices (e.g., hardware capability, properties, device settings, device language, network capability, manufacturer, device model, OS, OS version, etc.) in the device information repository 314. Additionally, the host server 300 can store information about network providers and the various network service areas in the network service provider repository 316.

The communication enabled by network interface 308 allows for simultaneous connections (e.g., including cellular connections) with devices 350 and/or connections (e.g., including wired/wireless, HTTP, Internet connections, LAN, WiFi, etc.) with content servers/providers 310 to manage the traffic between devices 350 and content providers 310, for optimizing network resource utilization and/or to conserver power (battery) consumption on the serviced devices 350. The host server 300 can communicate with mobile devices 350 serviced by different network service providers and/or in the same/different network service areas. The host server 300 can operate and is compatible with devices 350 with varying types or levels of mobile capabilities, including by way of example but not limitation, 1G, 2G, 2G transitional (2.5G, 2.75G), 3G (IMT-2000), 3G transitional (3.5G, 3.75G, 3.9G), 4G (IMT-advanced), etc.

In general, the network interface 308 can include one or more of a network adaptor card, a wireless network interface card (e.g., SMS interface, WiFi interface, interfaces for various generations of mobile communication standards including but not limited to 1G, 2G, 3G, 3.5G, 4G type networks such as LTE, WiMAX, etc.), Bluetooth, WiFi, or any other network whether or not connected via a router, an access point, a wireless router, a switch, a multilayer switch, a protocol converter, a gateway, a bridge, a bridge router, a hub, a digital media receiver, and/or a repeater.

In the example of a device (e.g., mobile device 350) making an application or content request to an application server or content provider 310, the request may be intercepted and routed to the proxy server 325 which is coupled to the device 350 and the application server/content provider 310. Specifically, the proxy server is able to communicate with the local proxy (e.g., proxy 175 and 275 of the examples of FIG. 1 and FIG. 2A respectively) of the mobile device 350, the local proxy forwards the data request to the proxy server 325 in some instances for further processing and/or analysis to detect, identify, and prevent malware.

In one embodiment, the server 300, through the activity/behavior awareness module 366, is able to identify or detect user activity at a device that is separate from the mobile device 350. For example, the module 366 may detect that a user's message inbox (e.g., email or types of inbox) is being accessed. This can indicate that the user is interacting with his/her application using a device other than the mobile device 350 and therefore any application data traffic from the user's mobile device 350 may come from a potentially harmful application.

The repositories 312, 314, and/or 316 can additionally store software, descriptive data, images, system information, drivers, and/or any other data item utilized by other components of the host server 300 and/or any other servers for operation. The repositories may be managed by a database management system (DBMS), for example, which may be but is not limited to Oracle, DB2, Microsoft Access, Microsoft SQL Server, PostgreSQL, MySQL, FileMaker, etc.

The repositories can be implemented via object-oriented technology and/or via text files and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package.

FIG. 3B depicts a block diagram illustrating examples of additional components in proxy server 325 shown in the example of FIG. 3A, which is further capable of performing malware detection, identification, and prevention based on application behavior and/or traffic priority.

In one embodiment of the proxy server 325, the traffic analyzer 336 monitors mobile data traffic for indicators of potentially harmful applications on one or more mobile devices (e.g., mobile device 250 of FIGS. 2A-2D). In general, the proxy server 325 is remote from the mobile devices and remote from the host server, as shown in the examples of FIGS. 1B-1C. The proxy server 325 or the host server 300 can monitor the data traffic for multiple mobile devices.

The traffic analyzer 336 of the proxy server 325 or host server 300 can include one or more of a prioritization engine 341a, a time criticality detection engine 341b, an application state categorizer 341c, and/or an application traffic categorizer 341d.

Each of these engines or modules can track different criterion for what is considered priority, time critical, background/foreground, or interactive/maintenance based on different wireless carriers. Different criterion may also exist for different mobile device types (e.g., device model, manufacturer, operating system, etc.). In some instances, the user of the mobile devices can adjust the settings or criterion regarding traffic category and the proxy server 325 is able to track and implement these user adjusted/configured settings.

In one embodiment, the traffic analyzer 336 is able to detect, determine, identify, or infer the activity state of an application on one or more mobile devices (e.g., mobile device 150 or 250) that traffic has originated from or that traffic is directed to, for example, via the application state categorizer 341c and/or the traffic categorizer 341d. The activity state can be determined based on whether the application is in a foreground or background state on one or more of the mobile devices (via the application state categorizer 341c) since the traffic for a foreground application vs. a background application may be analyzed differently for detecting malware. The malware detector may use the activity state as part of the device activity signature or data traffic signature to be used for detecting malware.

In the alternate or in combination, the activity state of an application can be determined by the wirelessly connected mobile devices (e.g., via the application behavior detectors in the local proxies) and communicated to the proxy server 325. For example, the activity state can be determined, detected, identified, or inferred with a level of certainty of heuristics, based on the backlight status at mobile devices (e.g., by a backlight detector) or other software agents or hardware sensors on the mobile device, including but not limited to, resistive sensors, capacitive sensors, ambient light sensors, motion sensors, touch sensors, etc. In general, if the backlight is on, the traffic can be treated as being or determined to be generated from an application that is active or in the foreground, or the traffic is interactive. In addition, if the backlight is on, the traffic can be treated as being or determined to be traffic from user interaction or user activity, or traffic containing data that the user is expecting within some time frame.

The activity state can be determined from assessing, determining, evaluating, inferring, or identifying user activity at the mobile device 250 (e.g., via the user activity module 215) and communicated to the proxy server 325. In one embodiment, the activity state is determined based on whether the traffic is interactive traffic or maintenance traffic. Interactive traffic can include transactions from responses and requests generated directly from user activity/interaction with an application and can include content or data that a user is waiting or expecting to receive. Maintenance traffic may be used to support the functionality of an application which is not directly detected by a user. Maintenance traffic can also include actions or transactions that may take place in response to a user action, but the user is not actively waiting for or expecting a response.

FIG. 3C depicts a block diagram illustrating additional components in the malware manager and filter engine 501 shown in the example of FIG. 3A.

Referring to FIG. 3C, in one embodiment, the malware manager and filter engine 501 includes a suspicious traffic interceptor 505, a malware detection engine 515, a malware notification module 525 and/or a malware traffic handler 535. The malware manager and filter engine 501 can be coupled to a cache 585 as shown or internally include the cache 585 in part or in whole. As described in detail in FIG. 1A, the suspicious traffic interceptor 505 can block, interrupt, or re-direct any malicious, potentially malicious, or otherwise suspicious traffic that is outgoing from the mobile device or incoming to the mobile device. Malware can be detected by the malware manager and filter engine 501 via the malware detection engine 515. The proxy can also identify malicious traffic based on information provided by the local proxy (e.g., proxy 225 in the example of FIGS. 2-3) on a mobile device, for example.

The malware manager and filter engine 501 shown in FIG. 3C operates similarly to the malware manager and filter engine 401 shown in FIG. 2D. As explained above, the detection and identification of potentially harmful applications may be performed solely by the mobile device, solely by a remote server, or any combination of the mobile device and the remote server. Thus, the functionality described in the context of FIG. 2D may also be performed in the context of FIG. 3C, either independently or in conjunction with the analysis being performed by the malware manager and filter engine 401 on the mobile device. For example, the malware manager and filter engine 401 may analyze the data traffic of the mobile device to detect potentially harmful applications, while the malware manager and filter engine 501 analyzes the same data traffic to also detect potentially harmful applications. This is beneficial because the malware manager and filter engine 501 may have more information since it has data traffic from other mobile devices that it can incorporate into its analysis. It is also beneficial because if there is malware in the mobile device, then the mobile device may be disabled, but the remote server may still be able to perform the analysis.

The malware notification module 525 can similarly notify various parties (e.g., a device, device user, device OS, network service provider, application service provider, etc.) of suspicious activity or traffic and handle the traffic by the malware traffic handler 535 based on external input from the various parties, based on an internally maintained set of rules or instructions, or a combination of the above. For example, the suspicious traffic interceptor 505 and/or the malware detection engine 515 may be implemented or integrated in the activity/behavior awareness module 266 and 366 shown in the example of FIGS. 2-3.

The components including the suspicious traffic interceptor 505, the malware detection engine 515, the malware notification module 525 and/or the malware traffic handler 535 or the associated functionalities can reside in the proxy 325 or partially reside the proxy server 325 (e.g., for use with the activity behavior awareness module 266 or 366) in addition to the components in proxy server 325 or in lieu of. Additional or fewer components, modules, agents, and/or engines can be included in the proxy 325 or the malware manager and filter engine 501 and each illustrated component.

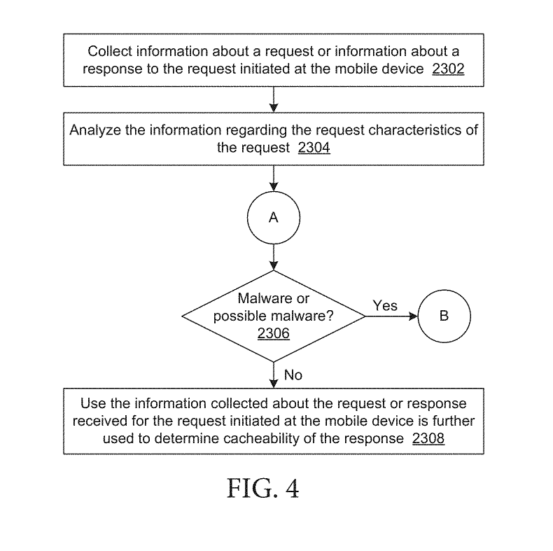

FIG. 4 depicts a flow chart illustrating an example process for using request characteristics information of requests initiated from a mobile device for malware detection, identification, and/or prevention.

In process 2302, information about a request or information about a response to the request initiated at the mobile device is collected. In one embodiment, the information includes request characteristics information associated with the request and/or response characteristics information associated with the response received for the request.

As explained above in the context of FIG. 2D, in various embodiments, the information collected at the mobile device may be information related to incoming data traffic to an application on the mobile device or information related to outgoing data traffic from an application on the mobile device. The information collected may further be information related to an application's behavior or device behavior. The information is collected by monitoring data traffic for one or more applications on the mobile device. The information collected may be used as an indicator that an application is a potentially harmful application.

In process 2304, the information regarding the request characteristics of the request is analyzed determine if there is malware or possible malware or other suspicious activity. As explained above in the context of FIG. 2D, in various embodiments, the information is analyzed based on different factors and/or indicators to determine whether an application is a potentially harmful application. For example, and as discussed above, an upload event may be an indicator, so the information included in or related to an upload event is analyzed to determine whether the application performing the upload event is a potentially harmful application.

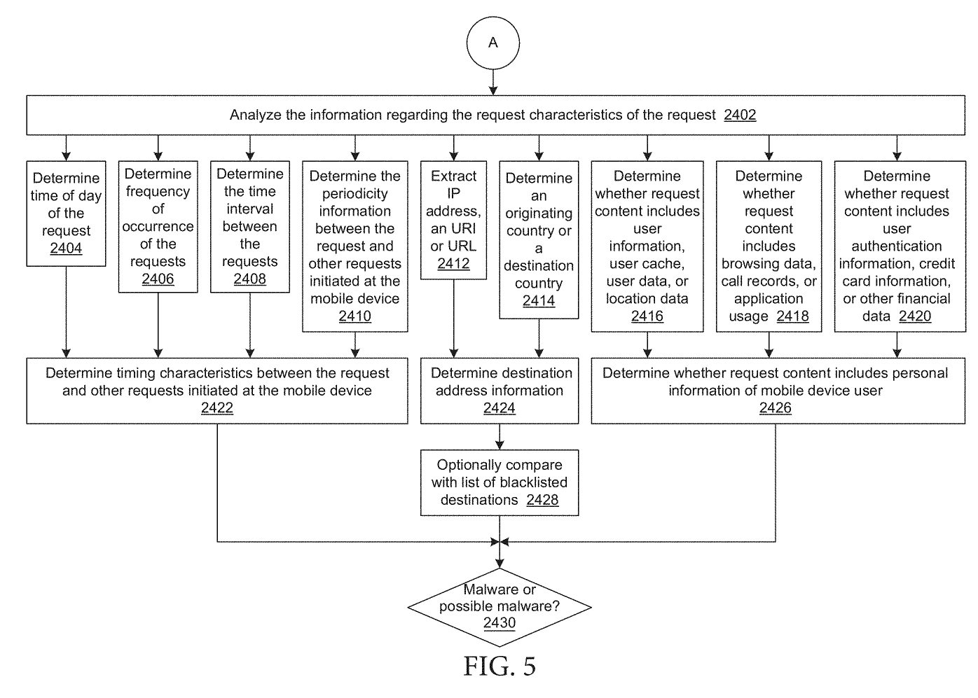

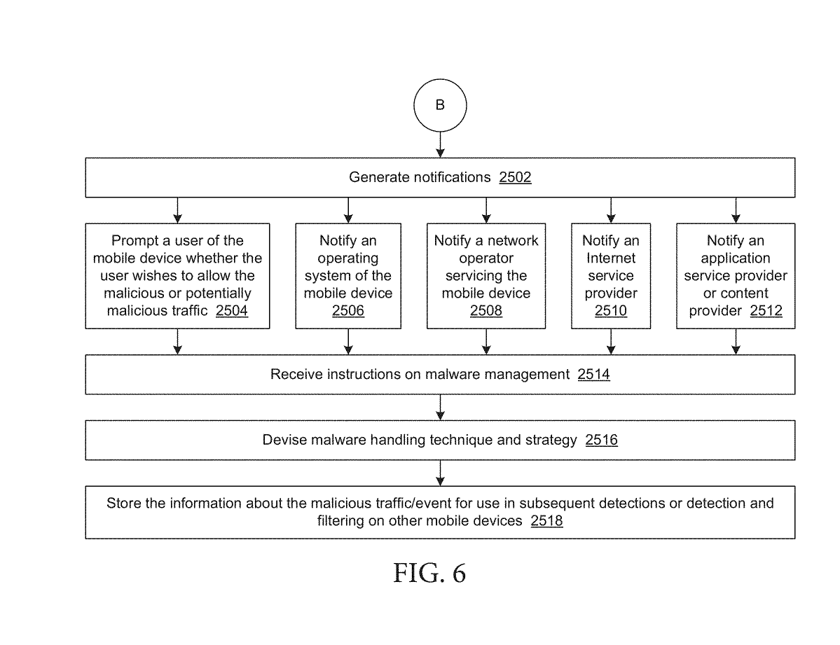

Examples of the analysis performed on the request characteristics are further illustrated at flow ‘A’ in FIG. 5. Malware or potentially malicious traffic, if detected at step 2306, is handled according to the steps illustrated in flow ‘B’ in the example of FIG. 6.

FIG. 5 depicts a flow chart illustrating example processes for analyzing request characteristics to determine or identify the presence of malware or other suspicious activity/traffic.

For example, timing characteristics between the request and other requests initiated at the mobile device are detected in process 2422. Timing characteristics can be detected by, one or more of, determining time of day of the request as in process 2404, determining frequency of occurrence of the requests as in process 2406, determining time interval between requests as in process 2408, and determining the periodicity information between the request and other requests initiated at the mobile device in process 2410. As explained above in the context of FIG. 2D, timing characteristics of data traffic can be an indicator of a potentially harmful application. For example, the frequency of one or more upload events, or the patterns of one or more uploads events, or upload events occurring immediately after installation/initialization of the application may be indicators that the application performing the upload event is a potentially harmful application.

For example, periodicity can be detected when the request and the other requests generated by the same client occur at a fixed rate or nearly fixed rate. In one embodiment, requests can be flagged as malicious or potentially containing malicious traffic when the requests from the same client have a change or significant change in the periodicity from prior requests.

In addition, destination address information can be determined in process 2424 for use in the analysis. Destination address information can be detected by, for example, extracting an IP address, an URI or URL in process 2412, or determining an originating country or a destination country 2414. In some instances patterns or parameters in the IP addresses or other identifiers such as the URI and/or URL are identified as indicators of suspicious activity or traffic which can indicate the presence of malware or other malicious traffic. Repeated occurrences of certain parameters or patterns can also indicate suspicious activity or malicious traffic and be tracked down.

Similarly, destinations, routes, and/or origins determined from IP addresses, URLs, URIs or other identifiers of request can be used for flagging suspicious activity. For example, specific origin countries, destination countries, or countries on a route of a request can indicate a higher likelihood of the traffic being malicious. In one embodiment, the destination address information or other location information can be compared with a list of blacklisted destination or origins or locations to determine whether the request contains malicious traffic or is related to other suspicious activity. The one or more blacklisted destinations can be stored on the proxy server and aggregated from analysis of traffic requests of multiple mobile devices.

In one embodiment, destination address information can be used to identify suspicious destinations based on a client making the request relative to a specified destination of the request. Specifically, the system can determine whether the specified destination of the request is an expected destination according to the client that is or appearing to make the request. Expected or known destinations of commonly used applications, clients, sites or widgets can be maintained and used for comparison.

In various embodiments, the system may identify suspicious destinations or known destinations used by malware using artificial intelligence or machine learning. For example, as explained in the context of FIG. 2D, the destinations of data traffic can be analyzed offline or at a remote server to identify suspicious destinations. The system may aggregate many upload events or other types of data traffic to analyze them on a large scale, which may allow for suspicious destinations to be identified even when analyzing that information for a single mobile device would not reveal anything suspicious. As one example, if a legitimate application server were to be hacked, then it that server may go from a non-suspicious destination to a suspicious destination quickly, and without any warning to the mobile application. A remote server analyzing data traffic to that hacked server over time may notice that the types of data requests/responses being sent to/from the hacked server all now include a particular piece of suspicious information that they previously had not included. This could be identified using machine learning or artificial intelligence.

In one embodiment, whether request content includes personal information of mobile device user can be used to detect malware or other suspicious activity in process 2426. Personal information can be identified by, for example, determining request content includes user information, user cache, user data, or location data in process 2416, determining whether request content includes browsing data, call records, or application usage 2418, or whether request content includes user authentication information, credit card information, or other financial data in process 2420. Under some circumstances, in response to detection that the content of the requests includes personal information, the traffic containing the requests is identified or flagged as malicious or potentially malicious.

In various embodiments, as explained above in the context of FIG. 2D, the information included in the data traffic may be an indicator that the application sending the information is a potentially harmful application. For example, when the data traffic includes more information during upload/uplink transmission than during download/downlink transmission, the system may recognize that the upload information includes personal information for user tracking and/or reporting. Similarly, when the data traffic includes large uploads/uplink transmissions, the system may recognize that the upload information includes personal information for user tracking and/or reporting. As also explained above, upload information may include a constant value across multiple uploads for the same user but a different constant value across multiple uploads for a different user. The system may recognize this difference at a remote server. In such a case, the system may determine that the application is including an assigned user identifier for tracking the user's behavior on the application/device.

Note that in general, the requests that are monitored and characteristics analyzed can be made by a same application or appearing to be made by the same application on the mobile device (e.g., malwares or malicious activity that affect specific applications or application types). The requests may also be made by different applications on the mobile device (e.g., instances where malicious activity is affecting the behavior of or utilizing the functionalities across all or multiple applications/widgets on a device). Using any combination of the above extracted information, the system can make an assessment as to whether there is malware or possible malware in process 2430.

FIG. 6 depicts a flow chart illustrating example processes for malware handling when malware or other suspicious activity is detected.

In process 2502, notifications that suspicious or malicious traffic has been detected are generated. The notification can prompt a user of the mobile device whether the user wishes to allow the malicious or potentially malicious traffic as in process 2504, notify an operating system of the mobile device as in process 2506, notify a network operator servicing the mobile device as in process 2508, notify an Internet service provider as in process 2510, and/or notify an application service provider or content provider, as in process 2512.

In process 2514, the system receives instructions from one or more of the above entities on how to handle the detected or suspected malware/malicious traffic and can devise a handling strategy in process 2516. In one embodiment, the information about the malicious traffic/event is stored for use in subsequent detections or detection and filtering on other mobile devices serviced by the distributed system.

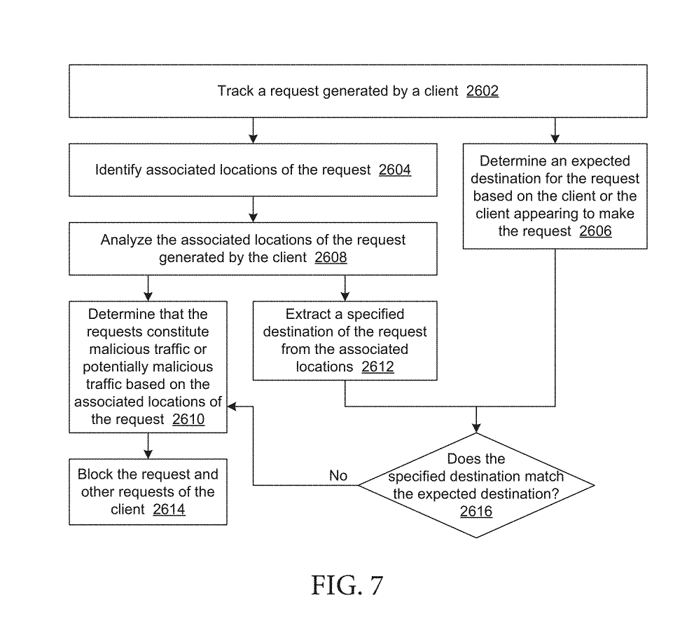

FIG. 7 depicts a flow chart illustrating an example process for detection or filtering of malicious traffic on a mobile device based on associated locations of a request.

In process 2602, a request generated by a client or application on a mobile device is tracked. In process 2608, the associated locations of the request generated by the client are analyzed. The associated locations can include, the originating location, route (e.g., any intermediate locations), and/or the destination location. In process 2610, it is determined that the requests constitute malicious traffic or potentially malicious traffic based on the associated locations of the request and in process 2612, the request and other requests of the client are blocked.

In process 2604, an expected destination for the request based on the client or the client appearing to make the request is determined and in process 2612, a specified destination of the request is extracted from the associated locations. It is determined at decision flow in 2616 whether the specified destination matches the expected destination. If not, it can be determined that the request possibly or likely constitutes malicious traffic or potentially malicious traffic and in process 2614, the request and other requests of the client, or requests/responses resulting therefrom are blocked.

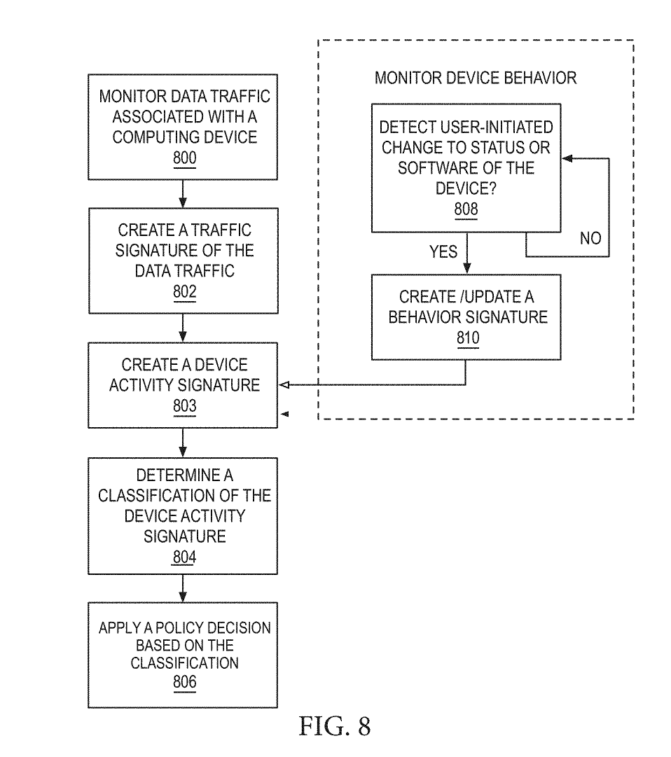

FIG. 8 depicts a flow diagram illustrating an example of a process for performing data traffic signature-based malware protection according to an embodiment of the subject matter described herein.

Referring to FIG. 8, the flow diagram shows a method of detecting a potentially harmful application. At step 800, data traffic associated with a computing device is monitored. The data traffic being monitored may be data traffic of a mobile application on a mobile device (e.g., the computing device). The data traffic can be monitored by data collection software installed on the computing device or on a remote server through which data traffic passes before being sent to its destination (e.g., a proxy server). Alternatively, device activity data normally recorded by the device can be collected. Many types of device activity may be automatically recorded by an operating system associated with the device and stored in counters, logs, or system files. Device activity information may be copied, extracted, parsed, or otherwise obtained from these sources for creating a traffic signature for the device. In one embodiment, characteristics of behavior of the mobile application are detected.

At step 802, a traffic signature is created for the data traffic. The traffic signature is an abstraction of the data traffic created by code over time when it executes. Traffic signatures are not precise specifications of traffic, as there may be variability across devices and across time. Traffic signatures can characterize all traffic from a device or traffic from one or more individual applications on the device. Examples of applications that may generate data traffic include Facebook, Outlook, and Google Cloud Messenger. Applications can include both downloaded and embedded applications. Components of a traffic signature can include various traffic metrics such as a volume of traffic (e.g., measured in bytes), a volume of connections (e.g., measured in total number of connections), application errors (e.g., including error type and total number of errors). Traffic signature components can also be expressed as a range, an average, or any other suitable method.

In one or more embodiments, metrics may include network destination, network protocols, application protocol, IP port, patterns in the content of the transmission, device location, network technology in use, application transmitting or receiving the data, combinations thereof, or one of these characteristics individually.

At step 803, a device activity signature is created. As will be discussed in greater detail below, the device activity signature may include a behavior signature in combination with the traffic signature of the mobile device. The traffic signature may be based on monitored data traffic while the behavior signature may be based on non-traffic data such as statuses of the device (e.g., backlight on/off, screen on/off), the OS (e.g., CPU utilization), and the apps (e.g., number of application errors, whether the application is in a foreground state or a background state, etc.).

At step 804, a classification of the device activity signature is determined. For example, the device activity signature may be compared with a reference device activity signature and classified as either normal or anomalous based on the comparison. In addition to classifying the device activity signature as either normal or anomalous, other suitable classifications can be determined.

Classifying the device activity signature can include determining a degree of similarity or a degree of difference between the device activity signature and a reference device activity signature. A reference signature can be a device activity signature based on a population of devices similar to the computing device or a device activity signature associated with the computing device at a previous time. For example, a reference device activity signature may be based on a population of phones that share similar model, cellular carrier, operating system, and/or geographic location as the computing device. Mathematical modeling can be used to determine a degree of similarity between the individual device activity signature of the computing device and the aggregated reference device activity signature from a population of multiple similar devices. Alternatively or additionally, the device activity signature can be compared with past device activity signatures for the same device. The device activity signature for the device may be obtained at various points in time (e.g., regular intervals) and saved for later comparison. For example, a sudden or dramatic change in the device activity signature of the device without a corresponding change to the status or software of the device that might explain the change in the device activity signature may be indicative of malware. In the event that the device's device activity signature is very different from other similar devices but is consistent with itself over time, this may mitigate against classifying the device activity signature as anomalous. In one embodiment, one or more indicators that the mobile application is a potentially harmful application may be identified. The one or more indicators that the mobile application is a potentially harmful application may be based on the data traffic of the mobile application and the characteristics of behavior of the mobile application.

By comparing accurate, refined, and dynamically updated device activity signatures with various reference device activity signatures, the subject matter herein efficiently captures anomalies and minimizes false-positives. First, additional behavioral information can be used to adjust expectations as to what is normal and what is an anomaly. Second, aggregation of similar application mixes on similar devices can be used to create and refine the device activity signature. Traffic or connection interval patterns can also be used to capture anomalies and minimize false-positives. Mobile-cloud traffic, for example, typically includes a client-side application that periodically connects with a server-side application to check for new information (e.g., getting Facebook updates, email updates, news updates, etc.). These connections may follow regular patterns, and deviations from these patterns can signal potential threats to the device.

Behavioral information can be used to determine the classification of a device activity signature. For example, screen-on time within a particular application can be used to scale up a device activity signature (e.g., because increased screen-on time may show increased usage of that application, likely implying higher traffic). Another example of using behavioral information includes analyzing screen-on time aggregated across all device use, which may suggest a more active user overall. Traffic pattern expectations can be adjusted accordingly. Yet another behavioral example includes factoring day/peak usage versus sleep-time usage. Some background traffic may be communicated while the device is operating in a sleep mode, but it may be lower volume and of a different character than when the device is operating in an active mode (e.g., daytime when the user is likely to be awake). Changes due to traveling, such as changes in time zone, can also be included in the calculation of the traffic signature by including the local time. Behavioral information can also include determining whether the device is using Wi-Fi or radio cell. Traffic behavior may vary significantly depending on whether the device is using Wi-Fi or cellular radios (e.g., much more streaming is typical under Wi-Fi), and the traffic abstraction model may be adjusted to reflect these two environments.

Deeper knowledge of traffic patterns of certain high-frequency applications can also be used to determine the classification of a traffic signature by looking for patterns and anomalies in the traffic and factoring out normal traffic. For example, using knowledge from other devices can be used to greatly speed up the effectiveness of understanding the traffic patterns of a new device. The device activity signature of aggregation of similar application mixes on similar handsets can help to create the device activity signature. For example, the subject matter described herein may be installed and executed across a population of devices. Device activity signatures for the population may be uploaded using a cloud-based aggregation of data. The collective intelligence (e.g., traffic signatures, device application make up, models, CPU power and other device features, etc.) can be made available to increase the overall efficiency of data collection and abstraction of device signatures, and to increase the accuracy of applying those signatures to monitor future traffic. Activity information about similar devices can greatly increase the speed and accuracy of device activity signature model. In one embodiment, the one or more indicators are analyzed to determine whether the mobile application is a potentially harmful application. Based on the analysis of the one or more indicators, the mobile application is classified as a potentially harmful application.

In one embodiment, the computational load associated with creating a device activity signature and classifying the device activity signature can be divided between the client device and a server device. Offloading some of the processing performed by the client device may minimize the power impact on the device, which may be important for mobile devices with limited CPU and battery power.

At step 806, a policy decision is applied based on the classification. Applying the policy decision can include, for example, logging the monitored data traffic, providing an alert to a user, or preventing an application or service from being executed by the computing device.

In addition to steps 800-802, which relate to monitoring data traffic and creating a traffic signature, device behavior may also be monitored for creation of a behavior signature. The device activity signature may incorporate aspects of both the traffic signature and the behavior signature. For example, the device activity signature can be updated to incorporate an expected device activity signature based on user-initiated changes to applications installed on the computing device. At step 808, for example, it is determined whether a user-initiated change to the status or software on the device has been detected. If a change is detected, the behavior signature is updated at step 810. For example, if the user has installed a new application on the device, such as a video streaming application, the traffic signature can be updated to include an expected rise in traffic volume associated with the video streaming application so as to not produce a false-positive classification of the signature as anomalous (e.g., indicative of malware). This may prevent an unwanted policy decision from being applied to the newly installed application, such as disabling its normal, expected, and user-desired video streaming functionality.

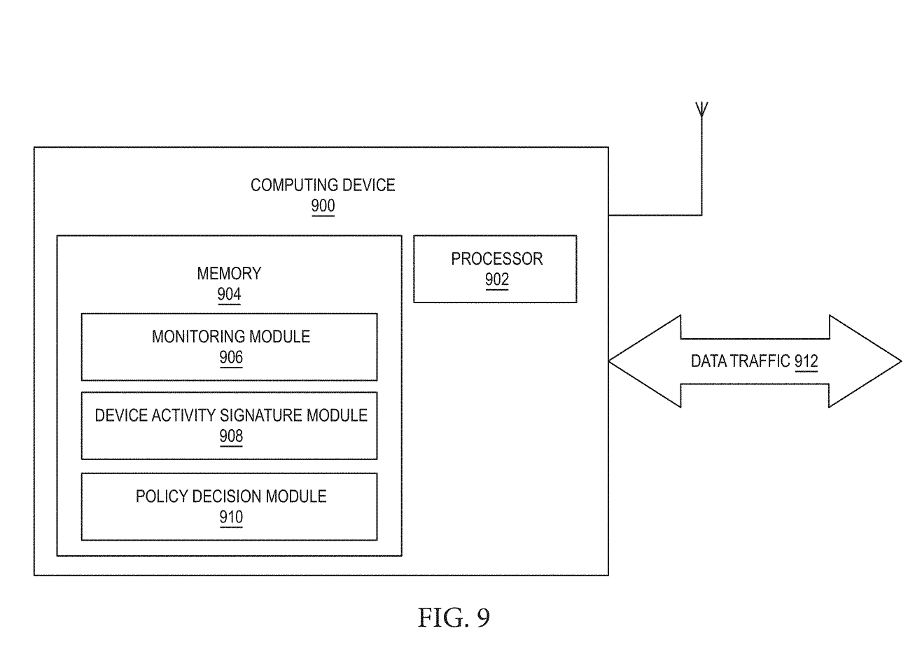

FIG. 9 depicts a block diagram illustrating an example of a computing device suitable for performing data traffic signature-based malware protection according to an embodiment of the subject matter described herein.

Referring to FIG. 9, computing device 900 may include a processor 902 and a memory 904. Executable code stored on memory 904 may be executed by processor 902. Memory 904 may include various functional modules including a monitoring module 906, a device activity module 908, and a policy decision module 910.

Monitoring module 906 is configured to monitor data traffic 912 associated with a computing device. The monitoring module 906 detects data traffic of a mobile application on a mobile device (e.g., the computing device). As described herein, in contrast to conventional configurations, which use code signatures for identifying and protecting against malware, the present disclosure uses data traffic signature. Monitoring module 906 can include data collection software installed on the computing device 900. Device activity data normally recorded by the device can also be collected by monitoring module 906. Device activity data can be stored in counters, logs, or system files (not shown) and device activity information may be copied, extracted, parsed, or otherwise obtained from these sources by monitoring module 906 for creating a traffic signature for the device 900. In one embodiment, the monitoring module 906 detects characteristics of behavior of the mobile application.

Traffic signature module 908 is configured to create a traffic signature of the data traffic that includes an abstraction of the data traffic. As described herein, the traffic signature may include a mathematical representation, abstraction, or model of the data traffic 912 associated with device 900. Functionality of device activity module 908 may be located entirely on computing device 900 or may be partially offloaded to a server (not shown) in order to reduce the power consumption of device 900. In one embodiment, the traffic signature module 908 includes an analysis engine that identifies one or more indicators that the mobile application is a potentially harmful application and determines, based on the analysis of the one or more indicators, whether the mobile application is a potentially harmful application. The one or more indicators may be based on the data traffic of the mobile application and the characteristics of behavior of the mobile application.

Policy decision module 910 is configured to determine a classification of the device activity signature and to apply a policy decision for the computing device based on the determined classification. For example, policy decision module 910 may compare the device activity signature with a reference device activity signature. If the device activity signature is sufficiently different from the reference device activity signature (e.g., larger that a predetermined threshold value), then the policy decision module 910 may classify the traffic signature as anomalous. Conversely, if the device activity signature is sufficiently similar from the reference device activity signature (e.g., less that a predetermined threshold value), then the policy decision module 910 may classify the device activity signature as normal. Policy decision module may then apply a policy decision for the computing device based on the determined classification. Examples of policy decision actions can include can noting the event in a log file to the immediate prevention/blocking of all activity associated with an application.

As used herein, the device activity signature may include a behavior signature in combination with the traffic signature of the mobile device. A behavior signature may be distinguished from a traffic signature based on the input data used to create the signature. For example, a traffic signature is associated with wireless traffic where the only data points used for characterizing the traffic are the wireless traffic (i.e., packets) itself. In contrast, a behavior signature is associated with a characterization of the behavior of the device which incorporates data other than wireless traffic data. For example, statuses or activity of a mobile device that may not be associated with any network traffic may include: a number of application errors, a type of application error, and an indication whether the screen is on or off and/or whether the user is engaging in other activity on the device such as typing or talking. Statuses or activity of a mobile device may also include user-initiated changes to applications installed on the computing device, such as activity associated with installing and executing a new application on the computing device. This may also include expected changes in the behavior of the device, such as increased data traffic for an application that is associated with an increase in user screen time for the application, a gradual increase in the volume of the data traffic over a predetermined period of time, or use of a new communication port known to be associated with installation and execution of a user-initiated application on the computing device. Thus, a device activity signature may be based on a traffic signature in combination with other device statuses or activity, operating system activity, and application activity. A device activity signature as described herein, therefore, can be used to detect threats, degradations in performance and other anomalies in device activity. It may be appreciated that threats to the device may either be solely caused by a specific malware or may be caused by a combination of device, network, and application issues. The present invention is capable of detecting, classifying, and applying a policy decision to both cases.

In one example of a malware threat that is based on a combination of factors, a device might have a hardware or firmware problem that shows up under certain network conditions and certain application activity as a large increase in TCP retries due to excessive processing delays within the firmware. The device may appear to be working, but the device is generating much more traffic on the network than necessary, and thus may have a shorter than expected battery life under such conditions.

In another example of a malware threat that is based on a combination of factors, traffic patterns from apps may appear to be normal (or only slightly abnormal), but the frequency of certain application and OS status and error codes begins to rise dramatically. In this case, the status/error codes are another source of information, which may not be directly attributable to a specific misbehaving app.

A traffic signature and/or a device behavior signature may also be used to monitor the “device health” associated with one or more applications executing on the mobile device. The “device health” of a mobile device may be determined based a device behavior signature. For example, deviations which are beyond expected behavior ranges may constitute a signal of potential “declining health.”

Device behavior (and the signature that is developed for a “healthy device”) may include, but is not limited to: all traffic as measured by bandwidth used per application and total for the device, size and patterns of data packets, mobile traffic as characterized by number of radio connections (aka “signaling”) and time connected, application errors and status codes, device operating system errors and status codes, and retransmissions and other changes to TCP and IP packet processing.

It may be appreciated that the expected behavior ranges may change over time due to various factors. For example, factors that may affect the expected behavior range of a mobile device that indicate whether a device is healthy may include new applications that add new traffic and/or other functions on the device. New apps adding new traffic may produce changes to the expected behavior of devices. These changes may be collected over time from the population of other subscribers who use that application. Thus, when a user adds that application to their device, the expected changes/behavior signatures may already be known for that application and incorporated into the behavior signature of the user's device. Other functions on the device may include, but are not limited to: changes in network coverage (e.g., from good to poor), changes in radio type (e.g., 2G, 3G, 4G, Wi-Fi, etc.), changes in battery level (e.g., Android OS may cause some applications to change their behavior when the battery is below a threshold), and whether the device is roaming or not roaming.

FIG. 10 depicts a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation. Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium (including, but not limited to, non-transitory computer-readable storage media). In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, a “module,” a “manager,” a “handler,” a “detector,” an “interface,” a “controller,” a “normalizer,” a “generator,” an “invalidator,” or an “engine” includes a general purpose, dedicated or shared processor and, typically, firmware or software modules that are executed by the processor. Depending upon implementation-specific or other considerations, the module, manager, handler, detector, interface, controller, normalizer, generator, invalidator, or engine can be centralized or its functionality distributed. The module, manager, handler, detector, interface, controller, normalizer, generator, invalidator, or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. § 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the disclosure.

What is claimed is:

1. A malware detector, comprising:
a data traffic monitor that detects data traffic of a mobile application on a mobile device;
an activity monitor that detects characteristics of behavior of the mobile application; and
an analysis engine that identifies, based on the data traffic of the mobile application and the characteristics of behavior of the mobile application, one or more indicators that the mobile application is a potentially harmful application and determines, based on an analysis of the one or more indicators, whether the mobile application is a potentially harmful application.

2. The malware detector of claim 1, wherein the analysis engine identifies one or more indicators that the mobile application is a potentially harmful application based on upload activity of the mobile application.

3. The malware detector of claim 2, wherein the upload activity used to identify one or more indicators includes data traffic containing personal information about a user of the mobile application or the mobile device.

4. The malware detector of claim 1, wherein the analysis engine identifies one or more indicators that the mobile application is a potentially harmful application based on behavior of the mobile application while the mobile application is operating in the background.

5. The malware detector of claim 4, wherein the behavior of the mobile application while the mobile application is operating in the background includes tracking the user's behavior on the mobile device.

6. The malware detector of claim 1, wherein the analysis engine uses machine learning to identify one or more indicators that the mobile application is a potentially harmful application and to determine whether the mobile application is a potentially harmful application.

7. The malware detector of claim 1, wherein the malware detector is communicatively coupled to a remote server that provides information to the malware detector that the analysis engine uses for identifying that the mobile application is a potentially harmful application.

8. A mobile device, comprising:
a memory; and
a processor,
wherein the processor is configured to:
monitor data traffic associated with a mobile application of the mobile device;
monitor device behavior of the mobile device; and
detect malware based on the data traffic and the device behavior,
wherein the processor detects malware by identifying one or more indicators and analyzing the one or more indicators.

9. The mobile device of claim 8, wherein the one or more indicators used to detect malware are identified based on upload activity of the mobile application.

10. The mobile device of claim 9, wherein the upload activity that is used to identify one or more indicators includes data traffic containing personal information about a user of the mobile application or the mobile device.

11. The mobile device of claim 8, wherein monitoring the device behavior includes monitoring activities of the mobile application while the mobile application is operating in the background.

12. The mobile device of claim 11, wherein the processor identifies one or more indicators when the mobile application is operating in the background based on the mobile application tracking the user's behavior on the mobile device while the mobile application is operating in the background.

13. The mobile device of claim 8, wherein analyzing the one or more indicators includes comparing the one or more indicators with information determined using machine learning.

14. The mobile device of claim 8, wherein the processor is further configured to flag detected malware.

15. A method of detecting a potentially harmful application, comprising:
monitoring data traffic of a mobile application on a mobile device;
detecting characteristics of behavior of the mobile application;
identifying one or more indicators that the mobile application is a potentially harmful application,
wherein the one or more indicators are based on the data traffic of the mobile application and the characteristics of behavior of the mobile application;
analyzing the one or more indicators to determine whether the mobile application is a potentially harmful application; and
classifying the mobile application as a potentially harmful application based on the analysis of the one or more indicators.

16. The method of claim 15, wherein the one or more indicators are based on upload activity of the mobile application.

17. The method of claim 15, wherein the one or more indicators are based on behavior of the mobile application while the mobile application is operating in the background.

18. The method of claim 15, wherein a threshold associated with a first indicator is determined using machine learning.

19. The method of claim 15, wherein a threshold associated with a first indicator is determined based on information provided by a third party.

20. The method of claim 15, wherein classifying the mobile application as a potentially harmful application is based on the presence of a plurality of indicators.
